(19) United States
(12) Patent Application Publication
(10) Pub. No.: US 2024/0275658 A1
(43) Pub. Date: Aug. 15, 2024

(54) FREQUENCY DIVISION MULTIPLEXED BEAM SWITCHING FOR DISCRETE FOURIER TRANSFORM-SPREAD-ORTHOGONAL FREQUENCY DIVISION MULTIPLEXING WAVEFORMS

(71) Applicant: QUALCOMM Incorporated, San Diego, CA (US)

(72) Inventors: Qiaoyu LI, Beijing (CN); Chao WEI, Beijing (CN); Hao XU, Beijing (CN); Yu ZHANG, San Diego, CA (US)

(21) Appl. No.: 18/569,048

(22) PCT Filed: Aug. 4, 2021
(86) PCT No.: PCT/CN2021/110465

§ 371 Date: Dec. 11, 2023

(51) Int. Cl. H04L 27/26; H04B 7/06

(52) U.S. Cl. CPC H04L 27/2636; H04B 7/0617

(57) ABSTRACT

Various aspects of the present disclosure generally relate to wireless communication. In some aspects, a receiving device may receive, from a transmitting device, an aggregated signal including a plurality of frequency division multiplexed (FDM) signals corresponding to a plurality of beams, each of the plurality of FDM signals comprising a waveform associated with a respective inverse fast Fourier transform (iFFT) component of a plurality of iFFT components. The receiving device may decode the plurality of FDM signals based at least in part on at least one of a geographical location, ephemeris information, or beam coverage information. Numerous other aspects are described.

### INTRODUCTION

Aspects of the present disclosure generally relate to wireless communication and to techniques and apparatuses for beam switching for frequency division multiplexing.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. NR, which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a receiving device. The apparatus may include a memory and one or more processors coupled to the memory. The memory and the one or more processors may be configured to receive, from a transmitting device, an aggregated signal including a plurality of frequency division multiplexed (FDM) signals corresponding to a plurality of beams. Each of the plurality of FDM signals may comprise a waveform associated with a respective inverse fast Fourier transform (iFFT) component of a plurality of iFFT components. The memory and the one or more processors may be configured to decode the plurality of FDM signals based at least in part on at least one of a geographical location, ephemeris information, or beam coverage information.

Some aspects described herein relate to an apparatus for wireless communication at a transmitting device. The apparatus may include a memory and one or more processors coupled to the memory. The memory and the one or more processors may be configured to generate, using a plurality of iFFT components, an aggregated signal including a plurality of FDM signals corresponding to a plurality of beams. Each of the plurality of FDM signals may comprise a waveform associated with a respective iFFT component of the plurality of iFFT components. The memory and the one or more processors may be configured to transmit the aggregated signal to a receiving device based at least in part on at least one of a geographical location, ephemeris information, or beam coverage information.

Some aspects described herein relate to a method of wireless communication performed by a receiving device. The method may include receiving, from a transmitting device, an aggregated signal including a plurality of FDM signals corresponding to a plurality of beams. Each of the plurality of FDM signals may comprise a waveform associated with a respective iFFT component of a plurality of iFFT components. The method may include decoding the plurality of FDM signals based at least in part on at least one of a geographical location, ephemeris information, or beam coverage information.

Some aspects described herein relate to a method of wireless communication performed by a transmitting device. The method may include generating, using a plurality of iFFT components, an aggregated signal including a plurality of FDM signals corresponding to a plurality of beams. Each of the plurality of FDM signals may comprise a waveform associated with a respective iFFT component of the plurality of iFFT components. The method may include transmitting the aggregated signal to a receiving device based at least in part on at least one of a geographical location, ephemeris information, or beam coverage information.

Some aspects described herein relate to a non-transitory computer-readable medium that stores a set of instructions for wireless communication by a receiving device. The set of instructions, when executed by one or more processors of the receiving device, may cause the receiving device to receive, from a transmitting device, an aggregated signal including a plurality of FDM signals corresponding to a plurality of beams. Each of the plurality of FDM signals may comprise a waveform associated with a respective iFFT component of a plurality of iFFT components. The set of instructions, when executed by one or more processors of the receiving device, may cause the receiving device to decode the plurality of FDM signals based at least in part on at least one of a geographical location, ephemeris information, or beam coverage information.

Some aspects described herein relate to a non-transitory computer-readable medium that stores a set of instructions for wireless communication by a transmitting device. The set of instructions, when executed by one or more processors of the transmitting device, may cause the transmitting device to generate, using a plurality of iFFT components, an aggregated signal including a plurality of FDM signals corresponding to a plurality of beams. Each of the plurality of FDM signals may comprise a waveform associated with a respective iFFT component of the plurality of iFFT components. The set of instructions, when executed by one or more processors of the transmitting device, may cause the transmitting device to transmit the aggregated signal to a receiving device based at least in part on at least one of a geographical location, ephemeris information, or beam coverage information.

Some aspects described herein relate to an apparatus for wireless communication. The apparatus may include means for receiving, from a transmitting device, an aggregated signal including a plurality of FDM signals corresponding to a plurality of beams. Each of the plurality of FDM signals may comprise a waveform associated with a respective iFFT component of a plurality of iFFT components. The apparatus may include means for decoding the plurality of FDM signals based at least in part on at least one of a geographical location, ephemeris information, or beam coverage information.

Some aspects described herein relate to an apparatus for wireless communication. The apparatus may include means for generating, using a plurality of iFFT components, an aggregated signal including a plurality of FDM signals corresponding to a plurality of beams. Each of the plurality of FDM signals may comprise a waveform associated with a respective iFFT component of the plurality of iFFT components. The apparatus may include means for transmitting the aggregated signal to a receiving device based at least in part on at least one of a geographical location, ephemeris information, or beam coverage information.

Aspects generally include a method, apparatus, system, computer program product, non-transitory computer-readable medium, user equipment, base station, wireless communication device, receiving device, transmitting device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a wireless communication network, in accordance with the present disclosure.

FIGS. 4 and 5 are diagrams illustrating examples associated with frequency division multiplexed (FDM) beam switching for waveforms, in accordance with the present disclosure.

FIGS. 6 and 7 are diagrams illustrating example processes associated with FDM beam switching for waveforms, in accordance with the present disclosure.

FIG. 8 is a diagram of an example apparatus for wireless communication, in accordance with the present disclosure.

FIG. 9 is a diagram illustrating an example of a hardware implementation for an apparatus employing a processing system, in accordance with the present disclosure.

FIG. 10 is a diagram illustrating an example implementation of code and circuitry for an apparatus, in accordance with the present disclosure.

FIG. 11 is a diagram of an example apparatus for wireless communication, in accordance with the present disclosure.

FIG. 12 is a diagram illustrating an example of a hardware implementation for an apparatus employing a processing system, in accordance with the present disclosure.

FIG. 13 is a diagram illustrating an example implementation of code and circuitry for an apparatus, in accordance with the present disclosure.

### DETAILED DESCRIPTION

Non-terrestrial network (NTN) implementations are increasingly being used to facilitate cellular communications. For example, NTN implementations may be used to support multiple-input multiple-output (MIMO) communications. In a wireless communication system, a transmitter may utilize multiple transmit antennas for data transmission to a receiver equipped with multiple receive antennas. The multiple transmit and receive antennas form a MIMO channel that may be used to increase throughput and/or improve reliability. For example, the transmitter may transmit multiple data streams simultaneously from the transmit antennas to improve throughput. Alternatively, the transmitter may transmit a single data stream from all of the transmit antennas to improve reception by the receiver.

To support MIMO communications, satellites may be outfitted with antenna arrays having the capability to generate beams and perform beamforming. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Discrete Fourier transform-spread-orthogonal frequency division multiplexing (DFT-s-OFDM) waveforms offer a promising tradeoff between resource allocation flexibility and peak-to-average-power ratio (PAPR). Orthogonal frequency division multiplexing (OFDM) is a multicarrier modulation technique that uses orthogonal subcarriers to transmit data. In the frequency domain, since the bandwidth of a subcarrier is designed to be smaller than the coherence bandwidth, each subchannel is seen as a flat fading channel which simplifies the channel equalization process. In the time domain, a high-rate data stream is split into a number of lower-rate data streams that are transmitted in parallel. A DFT-s-OFDM waveform is a waveform created by using a DFT process to spread the symbols across the subcarriers. The PAPR is the relationship between the maximum power of a sample in an OFDM transmission symbol divided by the average power of that OFDM symbol. In other words, PAPR is the ratio of peak power to the average power of a signal.

Zero-tail (ZT) and/or zero-head (ZH) DFT-s-OFDM waveforms may further provide flexible and efficient resource utilization. Zero-tail and/or zero-head DFT-s-OFDM waveforms are DFT-s-OFDM waveforms that have one or more zeros inserted in the tail of the data (at the end of the payload data) and/or at the head of the data (at the beginning of the payload data), before the signal is converted from a time-domain representation to a frequency-domain representation using a DFT operation. Guard interval (GI) signals can also be used with zero-tail and/or zero-head DFT-s-OFDM waveforms for time domain and/or frequency domain synchronization.

Frequency division multiplexed (FDM) or polarization-multiplexed adjacent beams can be useful for implementation in NTN scenarios to avoid inter-beam interference. FDM signals are signals that are transmitted at different frequencies in a time interval. Polarization-multiplexed adjacent beams are beams that are generated in the same space, time, and/or frequency, but have different polarizations. Analog beamforming networks and/or reflect arrays can be used for multiple FDM beams. However, analog implementation can make frequency-selective beamforming a DFT-s-OFDM signal difficult because the signal being fed to the antenna array (and/or other beamforming components that may be disposed upstream of the antenna array such as, for example, power splitters and/or phase shifters) is a single, aggregated output from an inverse Fast Fourier Transform (iFFT) component. An ability to more readily use frequency-selective beamforming may have a positive impact on network performance.

Some aspects of the techniques and apparatuses disclosed herein may facilitate frequency-selective beamforming by providing FDM beams that include a number of waveforms, each generated by a respective iFFTs component of a number of iFFT components. In some aspects, the waveforms may be DFT-s-OFDM waveforms. Generating each waveform using a respective iFFT component allows for preservation of frequency characteristics of each waveform when the waveforms are provided to the antenna elements for transmission. In some aspects, a transmitting device may transmit an aggregated signal including a plurality of FDM signals corresponding to a plurality of beams. Each of the plurality of FDM signals may include a waveform associated with a respective iFFT component of a plurality of iFFT components. A receiving device may receive and decode the plurality of FDM signals. In some aspects, the receiving device may decode the plurality of FDM signals based at least in part on at least one of a geographical location of the receiving device, ephemeris information associated with the transmitting device, or beam coverage information. In this way, some aspects may facilitate frequency-selective beamforming, which may facilitate more efficient and/or accurate identification, by the receiving device, of the FDM signals based on frequency characteristics thereof and, as a result, may have a positive impact on network performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure, For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

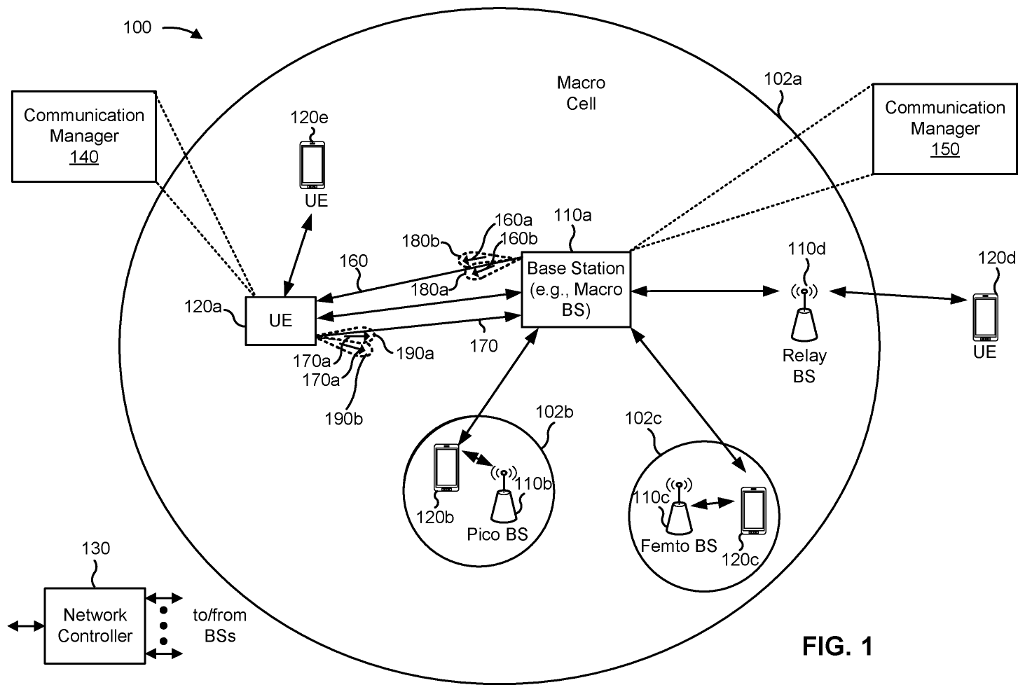

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

In some aspects, the wireless network 100 may include one or more non-terrestrial network (NTN) deployments in which a non-terrestrial wireless communication device may include a UE (referred to herein, interchangeably, as a “non-terrestrial UE”), a BS (referred to herein, interchangeably, as a “non-terrestrial BS” and “non-terrestrial base station”), a relay station (referred to herein, interchangeably, as a “non-terrestrial relay station”), and/or the like. As used herein, “NTN” may refer to a network for which access is facilitated by a non-terrestrial UE, non-terrestrial BS, a non-terrestrial relay station, and/or the like.

The wireless network 100 may include any number of non-terrestrial wireless communication devices. A non-terrestrial wireless communication device may include a satellite, a manned aircraft system, an unmanned aircraft system (UAS) platform, and/or the like. A satellite may include a low-earth orbit (LEO) satellite, a medium-earth orbit (MEO) satellite, a geostationary earth orbit (GEO) satellite, a high elliptical orbit (HEO) satellite, and/or the like. A manned aircraft system may include an airplane, helicopter, a dirigible, and/or the like. A UAS platform may include a high-altitude platform station (HAPS), and may include a balloon, a dirigible, an airplane, and/or the like. A non-terrestrial wireless communication device may be part of an NTN that is separate from the wireless network 100. Alternatively, an NTN may be part of the wireless network 100. Satellites may communicate directly and/or indirectly with other entities in wireless network 100 using satellite communication. The other entities may include UEs (e.g., terrestrial UEs and/or non-terrestrial UEs), other satellites in the one or more NTN deployments, other types of BSs (e.g., stationary and/or ground-based BSs), relay stations, one or more components and/or devices included in a core network of wireless network 100, and/or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrow band IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

The electromagnetic spectrum is often subdivided, by frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHz, FR 1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a receiving device (e.g., UE 120a or base station 110a) may include a communication manager 140 or 150, respectively. As described in more detail elsewhere herein, the communication manager 140 or 150 may receive, from a transmitting device (e.g., base station 110a or UE 120a), an aggregated signal 160 or 170, respectively, including a plurality of frequency division multiplexed (FDM) signals 160a and 160b or 170a and 170b, respectively, corresponding to a plurality of beams 180a and 180b or 190a and 190b, respectively. Each of the plurality of FDM signals 160a and 160 b or 170a and 170b may include a waveform associated with a respective inverse fast Fourier transform (iFFT) component of a plurality of iFFT components: and decode the plurality of FDM signals 160a and 160 b or 170a and 170b.

In some aspects, a transmitting device (e.g., base station 110a or UE 120a), may include a communication manager 150 or 140. As described in more detail elsewhere herein, the communication manager 150 or 140 may generate, using a plurality of iFFT components, an aggregated signal 160 or 170, respectively, including a plurality of FDM signals 160a and 160b or 170a and 170b, respectively, corresponding to a plurality of beams, 180a and 180b or 190a and 190b, respectively. Each of the plurality of FDM signals 160a and 160 b or 170a and 170b may include a waveform associated with a respective iFFT component of the plurality of iFFT components: and transmit the aggregated signal 160 or 170 to a receiving device (e.g., UE 120a or base station 110a). Additionally, or alternatively, the communication manager 150 or 140 may perform one or more other operations described herein.

As indicated above, FIG. 1 is provided as an example. Other examples may differ from what is described with regard to FIG. 1.

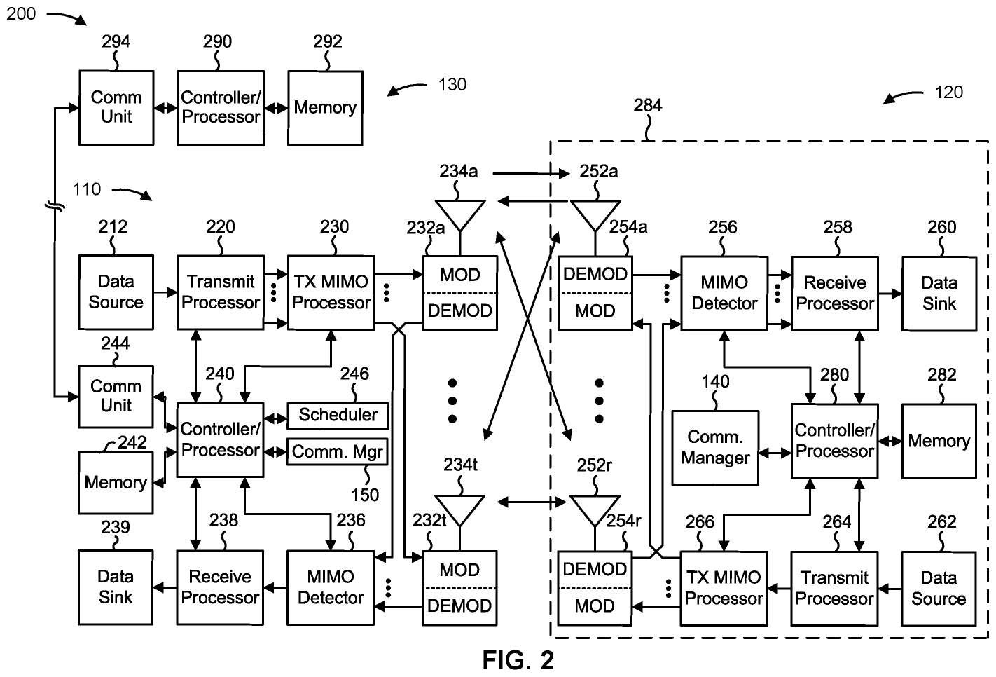

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The UE 120 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving RF signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

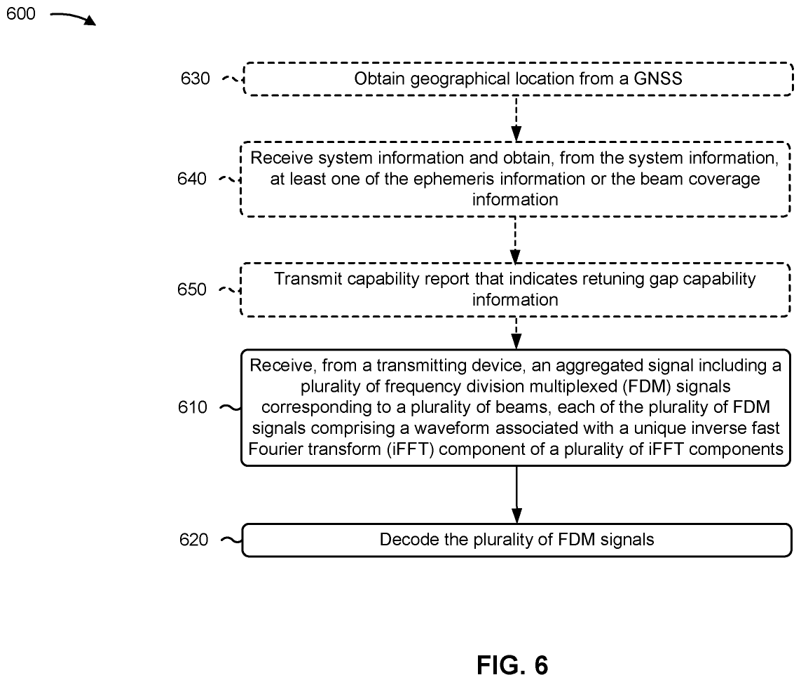

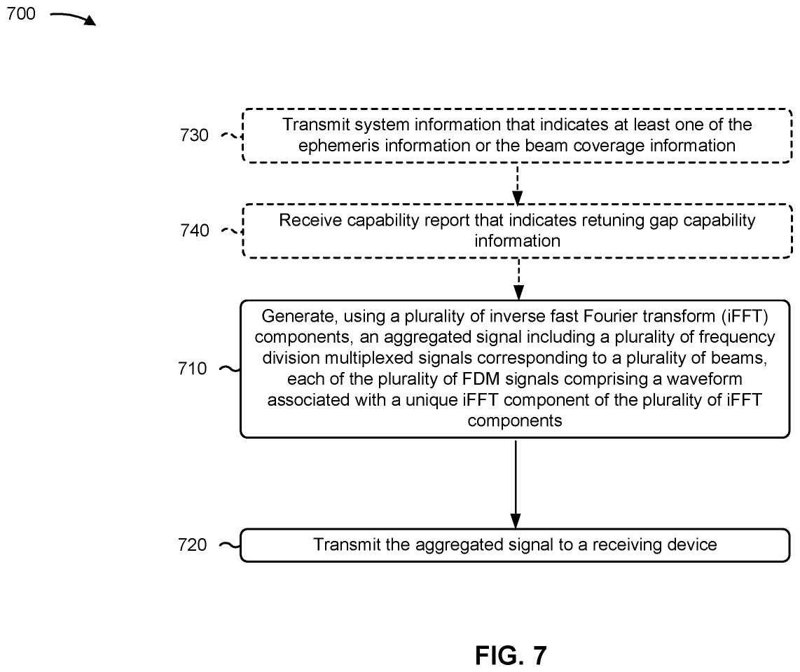

The controller/processor 240 of the base station 110, the controller/processor 280 of the UE 120, and/or any other component(s) of FIG. 2 may perform one or more techniques associated with beam switching for frequency division multiplexing, as described in more detail elsewhere herein. In some aspects, the receiving device or the transmitting device described herein is the base station 110, is included in the base station 110, or includes one or more components of the base station 110 shown in FIG. 2. In some aspects, the receiving device or the transmitting device described herein is the UE 120, is included in the UE 120, or includes one or more components of the UE 120 shown in FIG. 2. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a receiving device includes means for receiving, from a transmitting device, an aggregated signal including a plurality of FDM signals corresponding to a plurality of beams, each of the plurality of FDM signals comprising a waveform associated with a respective iFFT component of a plurality of iFFT components: and/or means for decoding the plurality of FDM signals based at least in part on at least one of a geographical location, ephemeris information, or beam coverage information. In some aspects, the means for the receiving device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the receiving device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a transmitting device includes means for generating, using a plurality of iFFT components, an aggregated signal including a plurality of FDM signals corresponding to a plurality of beams, each of the plurality of FDM signals comprising a waveform associated with a respective iFFT component of the plurality of iFFT components: and/or means for transmitting the aggregated signal to a receiving device based at least in part on at least one of a geographical location, ephemeris information, or beam coverage information. In some aspects, the means for the transmitting device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the transmitting device to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

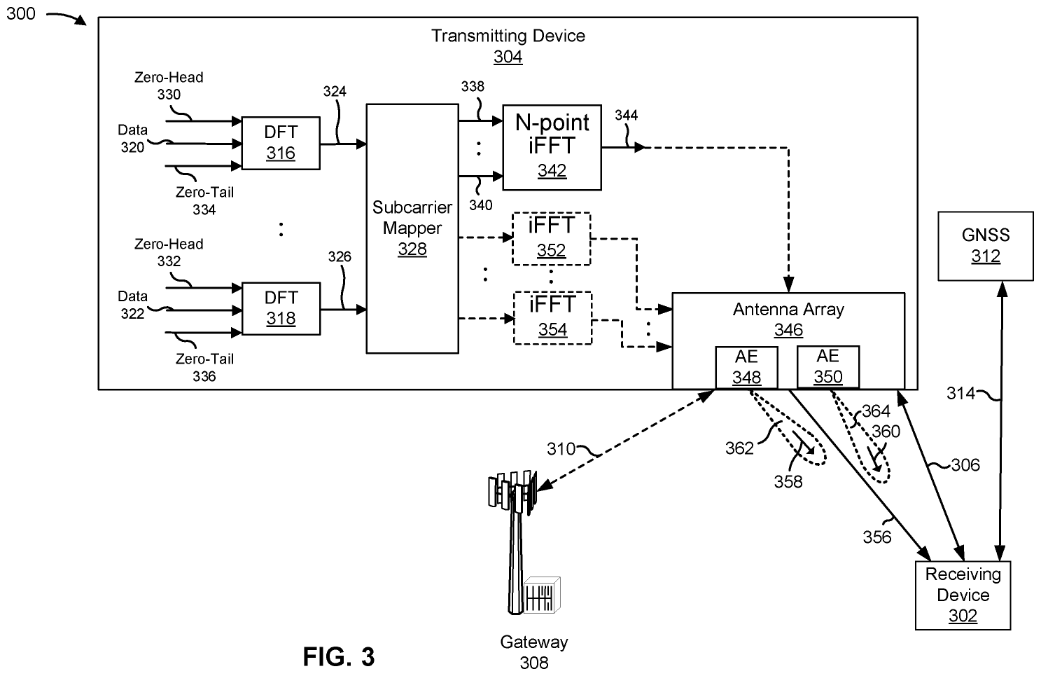

FIG. 3 is a diagram illustrating an example 300 of a wireless communication network, in accordance with the present disclosure. As shown, a receiving device 302 and a transmitting device 304 may communicate with one another. In some aspects, the receiving device 302 and/or the transmitting device 304 may include a UE, a base station, and/or a relay device, among other examples. In some aspects, example 300 may show an example of a NTN implementation.

For example, example 300 may show an example of a regenerative satellite deployment and an example of a transparent satellite deployment. In the example of the regenerative satellite deployment, the receiving device 302 may be a UE (e.g., UE 120 shown in FIGS. 1 and 2) that is served by the transmitting device 304, which may be a satellite, via a service link 306. For example, the transmitting device 304 may include a BS 110 (e.g., BS 110a), which may be, for example, a gNb. In some aspects, the transmitting device 304 may be associated with, and/or referred to as, a non-terrestrial base station, a regenerative repeater, or an on-board processing repeater. In some aspects, the transmitting device 304 may demodulate an uplink radio frequency signal and may modulate a baseband signal derived from the uplink radio signal to produce a downlink radio frequency transmission. The transmitting device 304 may transmit the downlink radio frequency signal on the service link 306. The transmitting device 304 may provide a cell that covers the receiving device 302.

In the example of a transparent satellite deployment, which may also be referred to as a bent-pipe satellite deployment, the receiving device 302 may be a UE that is served by the transmitting device 304, which may be a transparent satellite, via the service link 306. The transmitting device 304 may relay a signal received from a gateway 308 via a feeder link 310. For example, the transmitting device 304 may receive an uplink radio frequency transmission and may transmit a downlink radio frequency transmission without demodulating the uplink radio frequency transmission. In some aspects, the transmitting device 304 may frequency convert the uplink radio frequency transmission received on the service link 306 to a frequency of the uplink radio frequency transmission on the feeder link 310, and may amplify and/or filter the uplink radio frequency transmission. In some aspects, the UE 302 shown in example 300 may communicate with a Global Navigation Satellite System (GNSS) 312 via a positioning link 314. The transmitting device 304 may provide a cell that covers the receiving device 302 in a transparent satellite deployment as well.

The service link 306 may include a link between the transmitting device 304 and the receiving device 302, and may include one or more of an uplink or a downlink. The feeder link 310 may include a link between the transmitting device 304 and the gateway 308, and may include one or more of an uplink (e.g., from the receiving device 302 to the gateway 308) or a downlink (e.g., from the gateway 308 to the receiving device 302). The feeder link 310 and the service link 306 may each experience Doppler effects due to the movement of the transmitting device 304, and potentially movement of the receiving device 302. These Doppler effects may be significantly larger than in a terrestrial network. The Doppler effect on the feeder link 310 may be compensated for to some degree, but may still be associated with some amount of uncompensated frequency error.

As shown, the transmitting device 304 may include a number of discrete Fourier transform (“DFT”) components 316 and 318, each of which may receive data 320 and 322, respectively, and generate a transformed intermediate data signal 324 and 326, respectively, that is provided to a subcarrier mapper 328. Although the transmitting device 304 is shown as having two DFT components 316 and 318, in some examples, the transmitting device 304 may have more than two DFT components. As is also shown, in the case of zero-head and/or zero-tail DFT-s-OFDM waveforms, each of the DFT components 316 and 318 also may receive a zero-head 330 and/or 332, respectively, and/or a zero-tail 334 and/or 336, respectively, for incorporation into a resulting transformed intermediate data signal 324 and 326, respectively.

Zero-tail and/or zero-head DFT-s-OFDM waveforms may be waveforms that include a zero-tail—one or more zeros added to a tail (an end)—and/or a zero-head—one or more zeros added to a head (a beginning) of the data before the DFT processing. At the receiver, the zeros are extracted and discarded after iDFT processing. Zero-tail and/or zero-head DFT-s-OFDM waveforms may facilitate flexible bandwidth assignment and may have variable zero tail length, which can be used to facilitate similar cyclical functionality as cyclic prefix (CP), without the decreased spectral efficiency that can be introduced by CPs. Zero-tail and/or zero-head DFT-s-OFDM may be used with or without a guard interval (GI).

GIs may carry a sequence that can be used for time and/or frequency synchronization and/or channel estimation. Different GIs can be used by different UEs in uplink, accounting for different UE-specific delay spreads. In some cases, GI sequences may provide useful time domain autocorrelation for effective time and/or frequency tracking. Cross-correlation properties between different GIs may be used to reduce interference from GIs transmitted on the same resources in adjacent cells and/or for FDM UEs in uplink in the same cell. To maintain desirable out-of-band emission properties, a GI sequence can be generated in the frequency domain and up-sampled using an inverse DFT (iDFT) of a size equal to the delay spread that the system needs to account for. To use GIs with zero-tail and/or zero-head DFT-s-OFDM waveforms, before DFT, the original zeros in the zero-tail and/or zero-head DFT-s-OFDM waveform can be replaced with known sequences. Due to the linearity of the involved operations, the cascade of DFT, subcarrier mapping, and iFFT, each of the vectors contributing to the output signal features a significant energy only over a portion of the samples.

The transformed intermediate data signals 324 and 326 may be mapped to respective subcarriers by the subcarrier mapper 328 to generate mapped signals 338 and 340, respectively. The subcarrier mapper 328 outputs the mapped signals 338 and 340 to an N-point iFFT component 342 that is configured to generate an FDM signal 344, which may be outputted to an antenna array 346. The antenna array 346 may transmit the FDM signal 344 (e.g., to the receiving device 302).

In one or more examples, the antenna array 346 may include one or more reflectarray antennas. A reflectarray antenna (sometimes referred to as a “reflectarray”) includes an array of unit cells that are illuminated by a feeding antenna. The feeding antenna can be, for example, a horn. The unit cells can be backed by a ground plane and the incident wave from the feeding antenna reflects off of the unit cells in the direction of the beam. In some cases, a phase distribution of concentric rings can be applied to focus wavefronts from the feeding antenna into a plane wave. This can facilitate accounting for varying path lengths between the feeding antenna and the unit cells. A progressive phase shift can be applied to the unit cells to facilitate beam steering. In some cases, the feeding antenna can be offset from the beam path to prevent the feeding antenna from blocking the beam. Reflectarrays are increasingly desirable for satellite implementations in part because they focus the beam in a similar manner that a dish antenna (a parabolic reflector) focuses the beam, but with a much thinner form factor.

In one or more examples, the antenna array 346 can include a single-feed-per-beam (SFPB) configuration. The antenna array 346 can include four reflectors to provide cellular coverage in a four color reuse scheme (two frequencies and two polarizations), at both the transmitter and receiver frequencies. Neighboring color spots (regions of different combinations of frequency and polarization) are produced by different SFPB reflectors, which eliminates the risk of feed overlap and results in reasonably low spillover for a reflector diameter of roughly 2.4 m. The reflectors may be implemented in any number of different configurations. However, carrying four reflectors can lead to a high consumption of the satellite's volume and weight resources.

Some architectures enable a reduction of the number of antennas required to produce multispot coverage, such as those based on multiple-feed-per-beam reflectors, direct radiating arrays, and active lenses. However, the high complexity and cost of the feeding systems and beamforming networks can offset some of the advantages of these solutions when compared to standard SFPB systems. Reflectarrays can be configured with the ability to produce separate beams in different polarizations and/or frequencies (different colors) through a single feed, making it possible to reuse the same aperture to generate all of the spots associated with different colors.

In one or more examples, the antenna array 346 may include a single reflector with a multi-feed beamforming network (BFN). The function of the beamforming network is to provide proper phase and amplitude excitations to antenna elements (AEs) 348 and 350 of the array 346. Although the antenna array 346 is shown as having two AEs 348 and 350, in one or more examples, the antenna array 346 may have more than two AEs. The BFN requirements can become more stringent for transmitting antennas fed by amplifiers at the input of the network. In this case, the desire to avoid power waste leads to the network being designed to be lossless, and, in turn, the excitations to be mutually orthonormal. The single reflector with multi-feed BFN can be more favorable for small form factor satellites since only one aperture is needed. However, this design may be less suitable for low-cost satellites due to increased costs and complexity.

It can be advantageous to use a low peak-to-average-power ratio (PAPR) waveform for satellite communications. A satellite is power limited, while power amplifier efficiency is low at higher bands & large bandwidth, especially with CP-OFDM waveforms. Although single carrier (SC)-quadrature amplitude modulation (QAM) (or more recently introduced constant envelope (CE)-OFDM and/or phase modulation (PM)-OFDM) provides good PAPR performance, it may not be flexible enough for multi-user resource allocation as in OFDM. DFT-s-OFDM offers a more promising tradeoff compromising resource allocation flexibility and PAPR. Zero-tail and/or zero-head DFT-s-OFDM waveforms provide more flexible and efficient resource utilization than CP-DFT-s-OFDM, considering various multipath scenarios in NTN. Additionally, DFT-s-OFDM w/GI provides more efficient resource utilization than zero-tail and/or zero-head DFT-s-OFDM waveforms without GIs, as GI signals can be used for time domain and/or frequency domain synchronization.

FDM (or polarization-multiplexed) adjacent beams can be useful for implementation in NTN scenarios to avoid inter-beam interference. Analog beamforming networks and/or reflectarrays can be used for multiple FDM beams. However, analog implementation can make frequency-selective beamforming a wideband DFT-s-OFDM signal difficult because, in the case of either multi-beam reflector arrays or single reflector with multi-feed BFNs, the signal being fed to the antenna array (and/or other beamforming components that may be disposed upstream of the antenna array) is, as shown, a single, aggregated output from the N-point iFFT component 342. An ability to use frequency-selective beamforming may facilitate more efficient and/or accurate identification, by the second wireless communication device, of the FDM signals based on frequency characteristics thereof and, as a result, may have a positive impact on network performance.

Some aspects of the techniques and apparatuses disclosed herein may facilitate frequency-selective beamforming by providing FDM beams that include waveforms generated by respective iFFT components. For example, as shown in the dashed lines in FIG. 3, a transmitting device 304 may include a plurality of iFFT components 352 and 354. In some aspects, the transmitting device may transmit, and a receiving device 302 may receive, an aggregated signal 356 including a plurality of FDM signals 358 and 360 corresponding to a plurality of beams 362 and 364, respectively. The signal 358 may be transmitted using the AE 348, which may correspond to the beam 362, and the signal 360 may be transmitted using the AE 350, which may correspond to the beam 364. Each of the plurality of FDM signals 358 and 360 may include a waveform associated with a respective iFFT component 352 or 354 of the plurality of iFFT components. The receiving device 302 may decode the plurality of FDM signals 358 and 360. In this way, some aspects may facilitate frequency-selective beamforming and, as a result, have a positive impact on network performance.

As indicated above, FIG. 3 is provided as an example. Other examples may differ from what is described with regard to FIG. 3.

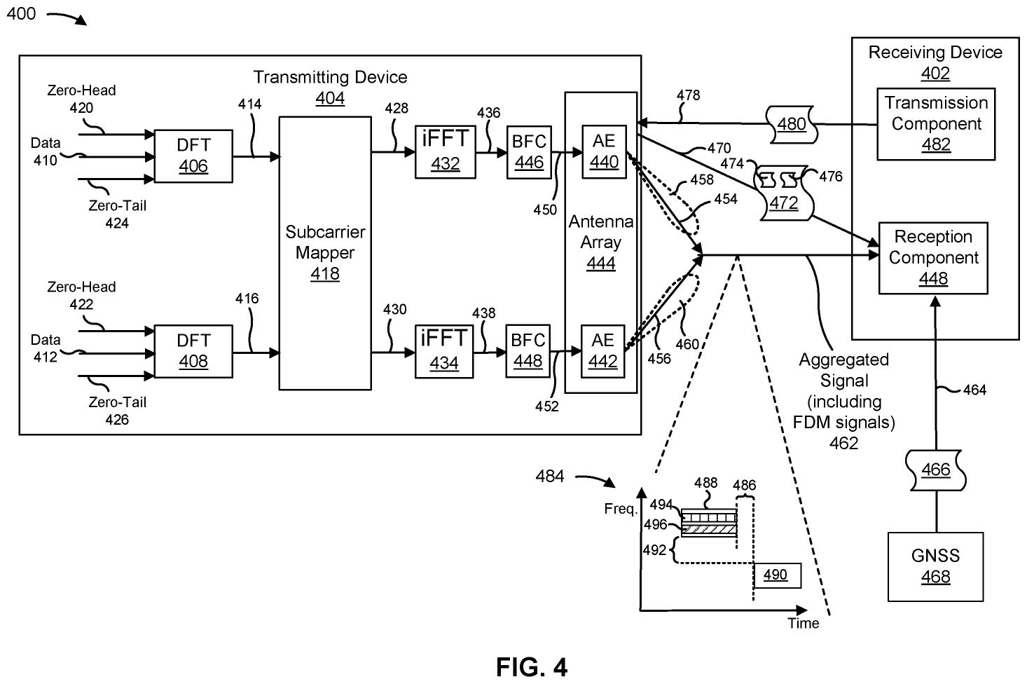

FIG. 4 is a diagram illustrating an example 400 of FDM beam switching for waveforms, in accordance with the present disclosure. As shown in FIG. 4, a receiving device 402 and a transmitting device 404 may communicate with one another. In some aspects, the transmitting device 404 and/or the receiving device 402 may be a UE, a base station, a relay device, and/or an NTN device. For example, in some aspects, the transmitting device 404 may be an NTN base station or an NTN relay device and the receiving device 402 may be a UE. In some aspects, the transmitting device 404 may be, or be similar to, the transmitting device 304 shown in FIG. 3. In some aspects, the receiving device 402 may be, or be similar to, the receiving device 302 shown in FIG. 3. In some aspects, the receiving device 402 may be referred to as a first device and/or a first wireless communication device and the transmitting device 404 may be revered to as a second device and/or a second wireless communication device. In some aspects, the transmitting device 404 may be referred to as a first device and/or a first wireless communication device and the receiving device 402 may be revered to as a second device and/or a second wireless communication device.

As shown, the transmitting device 404 may include a number of DFT components (shown as “DFT”) 406 and 408, each of which may receive data 410 and 412, respectively, and may generate a transformed intermediate data signal 414 and 416, respectively, that is provided to a subcarrier mapper 418. As is also shown, in the case of zero-head and/or zero-tail DFT-s-OFDM waveforms, each of the DFT components 406 and 408 also may receive a zero-head 420 and/or 422, respectively, and/or a zero-tail 424 and/or 426, respectively, for incorporation into a resulting transformed intermediate data signal 414 and 416, respectively. The subcarrier mapper 418 may map the intermediate data signals 414 and 416 to respective subcarriers and output the mapped signals 428 and 430 to a plurality of iFFT components 432 and 434. Each of the iFFT components 432 and 434 may be configured to generate a signal 436 and 438, respectively, each of which may be outputted to a respective AE 440 or 442 of an antenna array 444. In one or more examples, the antenna array 444 may include two or more AEs 440 and 442. Each AE of the antenna array may transmit a respective signal associated with a respective iFFT component.

In some aspects, one or more beamforming components (BFCs) 446 and 448 may be associated with the AE 440 and/or the AE 442. For example, one or more power splitters and/or phase shifters may be associated with the AE 440 and/or the AE 442 to support analog beamforming operations. The BFCs 446 and 448 may alter the signals 436 and 438, respectively, to generate altered signals 450 and 452, which, when transmitted by the respective AEs 440 and 442, may be transmitted as beamformed signals 454 and 456. The beamformed signals 454 and 456 may be frequency division multiplexed (FDM) by the AEs 440 and 442 and, thus, may be referred to as FDM signals 454 and 456. Each of the FDM signals 454 and 456 may, as a result of the beamforming, be associated with a respective beam 458 or 460. In one or more examples, each respective beam may be associated with a respective AE 440 or 442 of the antenna array 444.

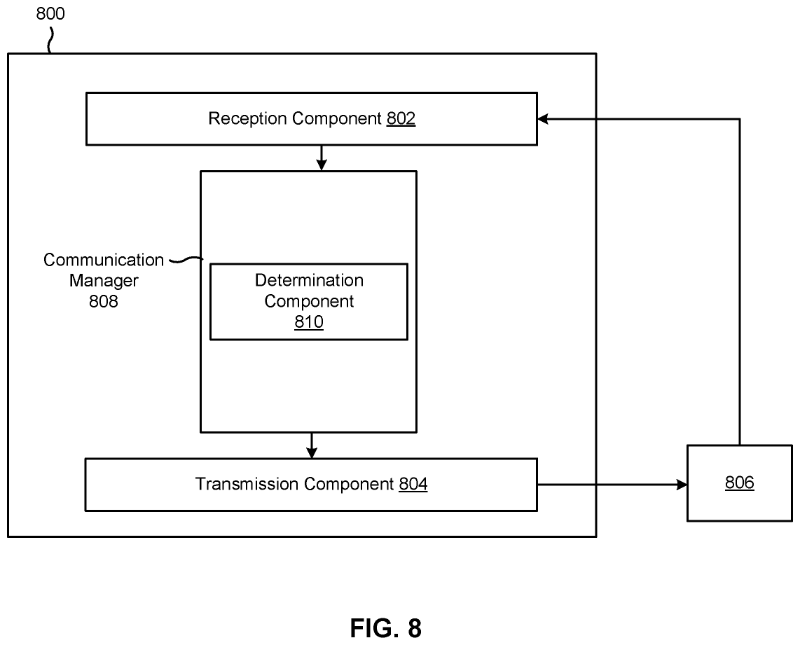

In some aspects, the AEs 440 and 442 may transmit the FDM signals 454 and 456 in an FDM fashion as an aggregated signal 462. The aggregated signal 462 may include the FDM signals 454 and 456. The plurality of FDM signals 454 and 456 may include at least one of a physical layer downlink channel communication, a physical layer uplink channel communication, or a reference signal. In some aspects, the FDM signals may include DFT-s-OFDM waveforms, zero-tail (ZT)-DFT-s-OFDM waveforms, and/or zero-head (ZH)-DFT-s-OFDM waveforms. The receiving device 402 may receive the aggregated signal 462 and decode the FDM signals 454 and 456. For example, as shown, the receiving device 402 may include a reception component 448 that receives the aggregated signal 462 and decodes the FDM signals 454 and 456. In some aspects, the reception component 448 may be, or be similar to, the reception component 802 shown in FIG. 8 and discussed below.

The reception component 448 may decode the FDM signals 454 and 456 based at least in part on one or more respective frequency characteristics of the FDM signals 454 and 456. As indicated above, the frequency characteristics of the FDM signals 454 and 456 may be preserved during encoding and transmission based at least in part on using respective iFFT components 432 and 434 to perform iFFT processing for generating the respective signals 454 and 456. In some aspects, the one or more frequency characteristics may include a central frequency, a subcarrier, a carrier, a frequency offset between a frequency associated with the signal 454 and a frequency associated with the signal 456, a frequency range, and/or a frequency band, among other examples. In some aspects, the transmitting device 404 may hop between a frequency associated with the beam 458 and a frequency associated with the beam 460 to facilitate transmitting the aggregated signal 462. In some aspects, the receiving device 402 may hop between the frequencies to facilitate receiving the aggregated signal 462 and decoding the FDM signals 454 and 456. In some aspects, the receiving device 402 may determine the plurality of FDM signals 454 and 456 based at least in part on at least one of a plurality of respective carrier frequencies corresponding to the plurality of FDM signals 454 and 456 or a plurality of respective polarizations corresponding to the plurality of FDM signals 454 and 456.

In some aspects, the receiving device 402 may decode the FDM signals 454 and 456 based at least in part on a geographical location of the receiving device 402, ephemeris information associated with the transmitting device 404, and/or beam coverage information. By using the geographical location, the ephemeris information, and/or the beam coverage information, the receiving device 402 is able to determine the one or more frequency characteristics of the FDM signals 454 and 456. For example, in some aspects, as shown by reference number 464, the receiving device 402 may determine the geographical location based on information 466 obtained (e.g., received via the reception component 448) from a geographical navigation satellite system (GNSS) 468. As shown by reference number 470, the transmitting device 404 may transmit (e.g., using the antenna array 444), and the receiving device 402 may receive (e.g., using the reception component 448), an indication 472 that indicates ephemeris information 474 associated with the transmitting device 404 and/or beam coverage information 476. The indication 472 may be carried in system information, a radio resource control (RRC) message, a medium access control (MAC) control element (MAC CE), and/or a downlink control information (DCI) transmission.

The beam coverage information may include at least one beam-specific parameter that indicates at least one of a carrier frequency, a number of iFFT points, a bandwidth, a subcarrier spacing, an indication of a portion of a zero-tail of a DFT-s-OFDM waveform to be considered and/or a portion of a zero-head of the DFT-s-OFDM waveform to be considered, a GI sequence to generate a GI in a time domain for a GI-DFT-s-OFDM waveform to be considered, at least a portion of the GI of the GI-DFT-s-OFDM waveform to be considered, or polarization information. The beam coverage information may include at least one of UE-specific beam coverage information or UE-group-specific beam coverage information. For example, UE-specific beam coverage information may indicate one or more transmission beams 458 and/or 460 that the transmitting device 404 may use to transmit data to the receiving device 402, frequency domain information associated with the one or more transmission beams 458 and/or 460, spatial domain information associated with the one or more transmission beams 458 and/or 460, and/or time domain information associated with the one or more transmission beams 458 and/or 460.

As shown by reference number 478, the receiving device 402 may transmit (e.g., using a transmission component 482), and the transmitting device 404 may receive (e.g., using the antenna array 444), a capability report 480. The capability report 480 may indicate retuning gap capability information associated with the receiving device 402. Retuning gap capability information may indicate one or more capabilities of the receiving device 402 to ascertain and/or utilize a retuning gap between frequency hops to facilitate retuning its reception component 448 to receive a different frequency, beam, and/or polarization.

For example, in one or more examples, as shown by the time/frequency representation 484 of the aggregated signal 462, the aggregated signal 462 may include at least one retuning gap 486 and the receiving device 402 may hop between the plurality of beams 458 and 460 by switching from a first beam 458 of the plurality of beams to a second beam 460 of the plurality of beams during the retuning gap 486. In some aspects, switching from the first beam 458 to the second beam 460 may include an inter-frequency beam switch. That is, for example, in some aspects, switching from the first beam 458 to the second beam 460 may include switching from a first frequency 488 associated with the first beam 458 to a second frequency 490 associated with the second beam 460. As shown, the at least one retuning gap 486 may include a non-zero retuning gap 486. A length of the non-zero retuning gap 486 may be based at least in part on a frequency offset 492 between the first frequency 488 and the second frequency 490. For example, a shorter retuning gap 486 may be associated with a smaller frequency offset 492, while a longer retuning gap 486 may be associated with a greater frequency offset 492.

In some aspects, switching from the first beam 458 to the second beam 460 may include an intra-frequency beam switch. The at least one retuning gap may include a zero retuning gap. In one or more examples, switching from the first beam 458 to the second beam 460 may include performing a hopping having a hopping type. The hopping type may include inter-frequency hopping with identical polarization, intra-frequency hopping with different polarization, or inter-frequency hopping with different polarization. In one or more examples, as shown, hopping between the plurality of beams 458 and 460 may include performing a bandwidth part (BWP) switch from a first active BWP 494 to a second active BWP 496. Each of the first active BWP 494 and the second active BWP 496 may have an associated set of parameters that indicates at least one of a carrier frequency, a number of iFFT points, a bandwidth, a subcarrier spacing, an indication of at least one of a portion of a zero-tail DFT-s-OFDM waveform to be considered or a portion of a zero-head DFT-s-OFDM waveform to be considered, a GI sequence to generate a GI in a time domain for a GI-DFT-s-OFDM waveform to be considered, at least a portion of the GI of the DFT-s-OFDM waveform to be considered, or polarization information.

In some aspects, the transmitting device 404 may include a UE and the aggregated signal 462 may be based at least in part on hopping based uplink beam switching. The hopping based uplink beam switching may use at least one of a frequency resource or a polarization. The at least one of the frequency resource or the polarization may be based at least in part on at least one frequency resource or polarization associated with the aggregated signal 462. The at least one of the frequency resource or the polarization may be based at least in part on at least one of a beam switching configuration or a wireless communication standard. In some aspects, the hopping based uplink beam switching may use at least one of a frequency resource or a polarization based at least in part on at least one of the geographical location of the transmitting device 404 (in this case, the UE), ephemeris information associated with the receiving device 402 (in this case, a non-terrestrial device), and/or the beam coverage information. The aggregated signal 462 may include at least one uplink retuning gap.

As indicated above, FIG. 4 is provided as an example. Other examples may differ from what is described with respect to FIG. 4.

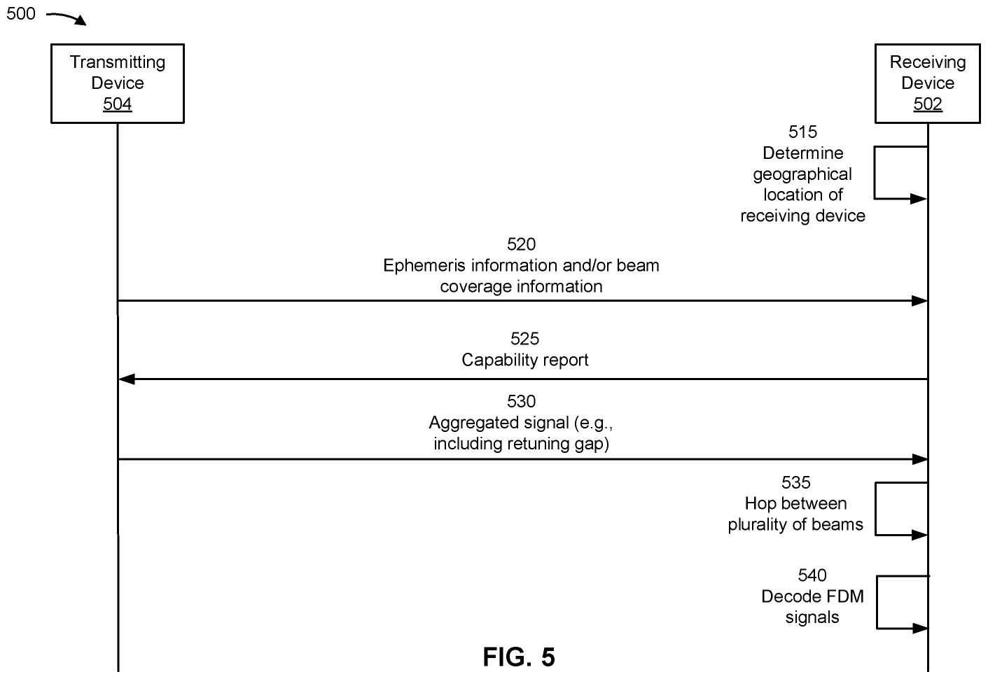

FIG. 5 is a diagram illustrating an example 500 associated with FDM beam switching for DFT-s-OFDM waveforms, in accordance with the present disclosure. As shown in FIG. 5, a receiving device 502 and a transmitting device 504 may communicate with one another. The transmitting device 504 may be, or be similar to, the transmitting device 404 shown in FIG. 4 and the receiving device 502 may be, or be similar to, the receiving device 402 shown in FIG. 4.

As shown by reference number 515, the receiving device 502 may determine a geographical location of the receiving device 502. For example, in some aspects, the receiving device 502 may determine the geographical location based on information obtained from a GNSS. As shown by reference number 520, the transmitting device 504 may transmit, and the receiving device 502 may receive, ephemeris information associated with the transmitting device 504 and/or beam coverage information. The ephemeris information and/or beam coverage information may be carried in system information, an RRC message, a MAC CE, and/or a DCI transmission, among other examples.

As shown by reference number 525, the receiving device 502 may transmit, and the transmitting device 504 may receive, a capability report. The capability report may indicate retuning gap capability information associated with the receiving device 502. As shown by reference number 530, the transmitting device 504 may transmit, and the receiving device 502 may receive, an aggregated signal. The aggregated signal may include a plurality of FDM signals. In some aspects, the plurality of FDM signals may correspond to a plurality of beams. Each of the plurality of FDM signals may include a DFT-s-OFDM waveform associated with a respective iFFT component of a plurality of iFFT components.

As shown by reference number 535, the receiving device 502 may hop between a plurality of beams, as explained above in connection with FIG. 4. As shown by reference number 540, the receiving device 502 may decode the plurality of FDM signals. The receiving device 502 may decode the plurality of FDM signals based at least in part on at least one of a geographical location of at least one of the receiving device 502 or the transmitting device 504 (for example, in cases in which the transmitting device is a UE), ephemeris information associated with at least one of the receiving device (for example, in cases in which the receiving device is a non-terrestrial device) or the transmitting device, or beam coverage information.

As indicated above, FIG. 5 is provided as an example. Other examples may differ from what is described with respect to FIG. 5.

FIG. 6 is a diagram illustrating an example process 600 performed, for example, by a receiving device, in accordance with the present disclosure. Example process 600 is an example where the receiving device (e e.g., receiving device 402 and/or receiving device 502) performs operations associated with FDM beam switching.

As shown in FIG. 6, in some aspects, process 600 may include receiving, from a transmitting device, an aggregated signal including a plurality of FDM signals corresponding to a plurality of beams, each of the plurality of FDM signals comprising a waveform associated with a respective iFFT component of a plurality of iFFT components (block 610). For example, the receiving device (e.g., using communication manager 808 and/or reception component 802, depicted in FIG. 8) may receive, from a transmitting device, an aggregated signal including a plurality of FDM signals corresponding to a plurality of beams, each of the plurality of FDM signals comprising a waveform associated with a respective iFFT component of a plurality of iFFT components, as described above.

As further shown in FIG. 6, in some aspects, process 600 may include decoding the plurality of FDM signals (block 620). For example, the receiving device (e.g., using communication manager 808 and/or reception component 802, depicted in FIG. 8) may decode the plurality of FDM signals, as described above.

Process 600 may include additional aspects, such as any single aspect or any combination of aspects described below and/or in connection with one or more other processes described elsewhere herein.

In a first aspect, the waveform comprises a DFT-s-OFDM waveform.

In a second aspect, alone or in combination with the first aspect, process 600 includes determining the plurality of FDM signals based at least in part on at least one of a plurality of respective carrier frequencies corresponding to the plurality of FDM signals or a plurality of respective polarizations corresponding to the plurality of FDM signals.

In a third aspect, alone or in combination with one or more of the first and second aspects, the plurality of FDM signals comprises at least one of a physical layer downlink channel communication, a physical layer uplink channel communication, or a reference signal.

In a fourth aspect, alone or in combination with one or more of the first through third aspects, decoding the plurality of FDM signals comprises decoding the plurality of FDM signals based at least in part on at least one of a geographical location of the receiving device, information associated with the transmitting device, or beaming coverage information.

In a fifth aspect, alone or in combination with the fourth aspect, process 600 includes obtaining the geographical location from a GNSS.

In a sixth aspect, alone or in combination with one or more of the fourth through fifth aspects, process 600 includes receiving system information, and obtaining, from the system information, at least one of the ephemeris information or the beam coverage information.

In a seventh aspect, alone or in combination with one or more of the fourth through sixth aspects, the beam coverage information comprises at least one beam-specific parameter that indicates at least one of a carrier frequency, a number of iFFT points, a bandwidth, a subcarrier spacing, an indication of at least one of a portion of a zero-tail of a DFT-s-OFDM waveform to be considered or a portion of a zero-head of the DFT-s-OFDM waveform to be considered, a GI sequence to generate a GI in a time domain for a GI-DFT-s-OFDM waveform to be considered, at least a portion of the GI of the GI-DFT-s-OFDM waveform to be considered, or information.

In an eighth aspect, alone or in combination with one or more of the fourth through seventh aspects, the beam coverage information comprises at least one of UE-specific beam coverage information or UE-group-specific beam coverage information.

In a ninth aspect, alone or in combination with the eighth aspect, process 600 includes receiving the beam coverage information via at least one of an RRC message, a MAC CE, or a DCI transmission.

In a tenth aspect, alone or in combination with one or more of the first through ninth aspects, process 600 includes hopping between the plurality of beams.

In an eleventh aspect, alone or in combination with the tenth aspect, the aggregated signal comprises at least one retuning gap, and wherein hopping between the plurality of beams comprises switching from a first beam of the plurality of beams to a second beam of the plurality of beams during the retuning gap.

In a twelfth aspect, alone or in combination with the eleventh aspect, switching from the first beam to the second beam comprises an inter-frequency beam switch, and wherein the at least one retuning gap comprises a non-zero retuning gap.

In a thirteenth aspect, alone or in combination with the twelfth aspect, a length of the non-zero retuning gap is based at least in part on a frequency offset between a frequency associated with the first beam and a frequency associated with the second beam.

In a fourteenth aspect, alone or in combination with one or more of the eleventh through thirteenth aspects, switching from the first beam to the second beam comprises an intra-frequency beam switch, and wherein the at least one retuning gap comprises a zero retuning gap.

In a fifteenth aspect, alone or in combination with one or more of the eleventh through fourteenth aspects, switching from the first beam to the second beam comprises performing a hopping having a hopping type, wherein the hopping type comprises inter-frequency hopping with identical polarization, intra-frequency hopping with different polarization, or inter-frequency hopping with different polarization.

In a sixteenth aspect, alone or in combination with one or more of the eleventh through fifteenth aspects, process 600 includes transmitting a capability report to the transmitting device that indicates retuning gap capability information, wherein the at least one retuning gap is based at least in part on the retuning gap capability information.

In a seventeenth aspect, alone or in combination with one or more of the tenth through sixteenth aspects, hopping between the plurality of beams comprises performing a BWP switch from a first active BWP to a second active BWP.

In an eighteenth aspect, alone or in combination with the seventeenth aspect, each of the first active BWP and the second active BWP has an associated set of parameters that indicates at least one of a carrier frequency, a number of iFFT points, a bandwidth, a subcarrier spacing, an indication of at least one of a portion of a zero-tail of a DFT-s-OFDM waveform to be considered or a portion of a zero-head of the DFT-s-OFDM waveform to be considered, a GI sequence to generate a GI in a time domain for a GI-DFT-s-OFDM waveform to be considered, at least a portion of the GI of the GI-DFT-s-OFDM waveform to be considered, or information.

In a nineteenth aspect, alone or in combination with one or more of the first through eighteenth aspects, the receiving device comprises a UE, the UE comprising a transceiver.

In a twentieth aspect, alone or in combination with one or more of the first through nineteenth aspects, the transmitting device comprises a UE, and wherein the aggregated signal is based at least in part on hopping based uplink beam switching.

In a twenty-first aspect, alone or in combination with the twentieth aspect, the hopping based uplink beam switching uses at least one of a frequency resource or a polarization, wherein the at least one of the frequency resource or the polarization is based at least in part on at least one frequency resource or polarization associated with the aggregated signal.

In a twenty-second aspect, alone or in combination with the twenty-first aspect, the at least one of the frequency resource or the polarization is based at least in part on at least one of a beam switching configuration or a wireless communication standard.

In a twenty-third aspect, alone or in combination with one or more of the twentieth through twenty-second aspects, decoding the plurality of FDM signals comprises decoding the plurality of FDM signals based at least in part on at least one of a geographical location of the UE, information associated with the receiving device, or beaming coverage information.

In a twenty-fourth aspect, alone or in combination with the twenty-third aspect, the hopping based uplink beam switching uses at least one of a frequency resource or a polarization, wherein the at least one of the frequency resource or the polarization is based at least in part on at least one of the geographical location of the UE, the ephemeris information associated with the receiving device, or the beam coverage information.

In a twenty-fifth aspect, alone or in combination with one or more of the twentieth through twenty-fourth aspects, the aggregated signal comprises at least one uplink retuning gap.

In a twenty-sixth aspect, alone or in combination with one or more of the first through twenty-fifth aspects, at least one of the receiving device or the transmitting device comprises a non-terrestrial device.

In a twenty-seventh aspect, alone or in combination with the twenty-sixth aspect, the non-terrestrial device is associated with a satellite.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a transmitting device, in accordance with the present disclosure. Example process 700 is an example where the transmitting device ((e.g., transmitting device 404 and/or transmitting device 504) performs operations associated with FDM beam switching.

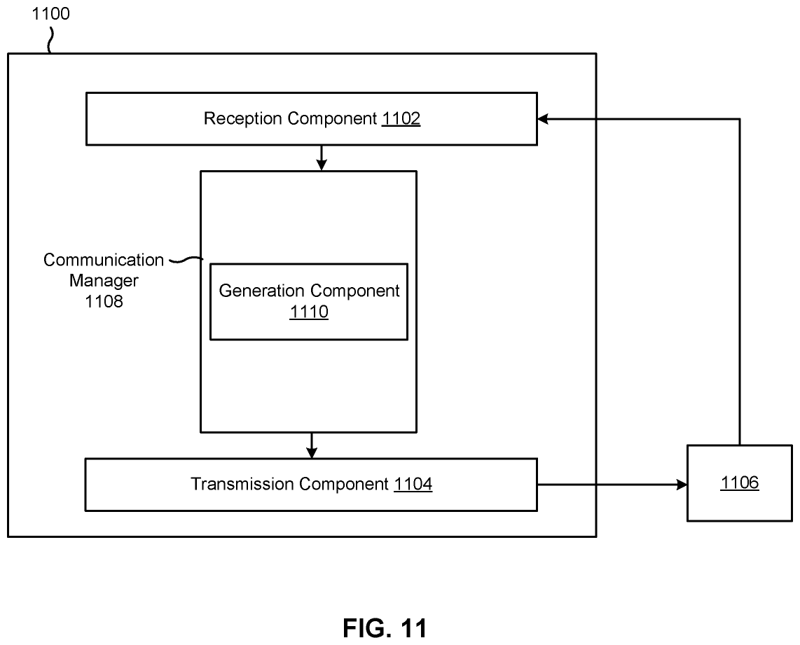

As shown in FIG. 7, in some aspects, process 700 may include generating, using a plurality of iFFT components, an aggregated signal including a plurality of FDM signals corresponding to a plurality of beams, each of the plurality of FDM signals comprising a waveform associated with a respective iFFT component of the plurality of iFFT components (block 710). For example, the transmitting device (e.g., using communication manager 1108 and/or generation component 1110, depicted in FIG. 11) may generate, using a plurality of iFFT components, an aggregated signal including a plurality of FDM signals corresponding to a plurality of beams, each of the plurality of FDM signals comprising a waveform associated with a respective iFFT component of the plurality of iFFT components, as described above.

As further shown in FIG. 7, in some aspects, process 700 may include transmitting the aggregated signal to a receiving device (block 720). For example, the transmitting device (e.g., using communication manager 1108 and/or transmission component 1104, depicted in FIG. 11) may transmit the aggregated signal to a receiving device, as described above.

Process 700 may include additional aspects, such as any single aspect or any combination of aspects described below and/or in connection with one or more other processes described elsewhere herein.

In a first aspect, the waveform comprises a DFT-s-OFDM waveform.

In a second aspect, alone or in combination with the first aspect, process 700 includes generating the plurality of FDM signals based at least in part on at least one of a plurality of respective carrier frequencies corresponding to the plurality of FDM signals or a plurality of respective polarizations corresponding to the plurality of FDM signals.

In a third aspect, alone or in combination with one or more of the first and second aspects, the plurality of FDM signals comprises at least one of a physical layer downlink channel communication, a physical layer uplink channel communication, or a reference signal.

In a fourth aspect, alone or in combination with one or more of the first through third aspects, transmitting the aggregated signal comprises transmitting the aggregated signal based at least in part on at least one of a geographical location of the receiving device, information associated with the transmitting device, or beaming coverage information.

In a fifth aspect, alone or in combination with the fourth aspect, process 700 includes obtaining the geographical location from a GNSS.

In a sixth aspect, alone or in combination with one or more of the fourth through fifth aspects, process 700 includes transmitting system information that indicates at least one of the ephemeris information or the beam coverage information.

In a seventh aspect, alone or in combination with one or more of the fourth through sixth aspects, the beam coverage information comprises at least one beam-specific parameter that indicates at least one of a carrier frequency, a number of iFFT points, a bandwidth, a subcarrier spacing, an indication of at least one of a portion of a zero-tail of a DFT-s-OFDM waveform to be considered or a portion of a zero-head of the DFT-s-OFDM waveform to be considered, a GI sequence to generate a GI in a time domain for a GI-DFT-s-OFDM waveform to be considered, at least a portion of the GI of the GI-DFT-s-OFDM waveform to be considered, or information.

In an eighth aspect, alone or in combination with one or more of the fourth through seventh aspects, the beam coverage information comprises at least one of UE-specific beam coverage information or UE-group-specific beam coverage information.

In a ninth aspect, alone or in combination with one or more of the fourth through eighth aspects, process 700 includes transmitting the beam coverage information via at least one of an RRC message, a MAC CE, or a DCI transmission.

In a tenth aspect, alone or in combination with one or more of the first through ninth aspects, process 700 includes hopping between the plurality of beams.

In an eleventh aspect, alone or in combination with the tenth aspect, the aggregated signal comprises at least one retuning gap, and wherein hopping between the plurality of beams comprises switching from a first beam of the plurality of beams to a second beam of the plurality of beams during the retuning gap.

In a twelfth aspect, alone or in combination with the eleventh aspect, switching from the first beam to the second beam comprises an inter-frequency beam switch, and wherein the at least one retuning gap comprises a non-zero retuning gap.

In a thirteenth aspect, alone or in combination with the twelfth aspect, a length of the non-zero retuning gap is based at least in part on a frequency offset between a frequency associated with the first beam and a frequency associated with the second beam.

In a fourteenth aspect, alone or in combination with one or more of the eleventh through thirteenth aspects, switching from the first beam to the second beam comprises an intra-frequency beam switch, and wherein the at least one retuning gap comprises a zero retuning gap.

In a fifteenth aspect, alone or in combination with one or more of the eleventh through fourteenth aspects, switching from the first beam to the second beam comprises performing a hopping having a hopping type, wherein the hopping type comprises inter-frequency hopping with identical polarization, intra-frequency hopping with different polarization, or inter-frequency hopping with different polarization.

In a sixteenth aspect, alone or in combination with one or more of the eleventh through fifteenth aspects, process 700 includes receiving a capability report from the receiving device that indicates retuning gap capability information, wherein the at least one retuning gap is based at least in part on the retuning gap capability information.

In a seventeenth aspect, alone or in combination with one or more of the tenth through sixteenth aspects, hopping between the plurality of beams comprises performing a BWP switch from a first active BWP to a second active BWP.

In an eighteenth aspect, alone or in combination with the seventeenth aspect, each of the first active BWP and the second active BWP has an associated set of parameters that indicates at least one of a carrier frequency. a number of iFFT points, a bandwidth, a subcarrier spacing, an indication of at least one of a portion of a zero-tail of a DFT-s-OFDM waveform to be considered or a portion of a zero-head of the DFT-s-OFDM waveform to be considered, a GI sequence to generate a GI in a time domain for a GI-DFT-s-OFDM waveform to be considered, at least a portion of the GI of the GI-DFT-s-OFDM waveform to be considered, or information.

In a nineteenth aspect, alone or in combination with one or more of the first through eighteenth aspects, the receiving device comprises a UE, the UE comprising a transceiver.

In a twentieth aspect, alone or in combination with one or more of the first through nineteenth aspects, the transmitting device comprises a UE, and wherein the transmitting the aggregated signal comprises transmitting a communication using hopping based uplink beam switching.

In a twenty-first aspect, alone or in combination with the twentieth aspect, the hopping based uplink beam switching uses at least one of a frequency resource or a polarization, wherein the at least one of the frequency resource or the polarization is based at least in part on at least one frequency resource or polarization associated with the aggregated signal.

In a twenty-second aspect, alone or in combination with the twenty-first aspect, the at least one of the frequency resource or the polarization is based at least in part on at least one of a beam switching configuration or a wireless communication standard.

In a twenty-third aspect, alone or in combination with one or more of the twentieth through twenty-second aspects, transmitting the aggregated signal comprises transmitting the aggregated signal based at least in part on at least one of a geographical location of the UE, information associated with the receiving device, or beaming coverage information.

In a twenty-fourth aspect, alone or in combination with the twenty-third aspect, the hopping based uplink beam switching uses at least one of a frequency resource or a polarization, wherein the at least one of the frequency resource or the polarization is based at least in part on at least one of the geographical location of the UE, the ephemeris information associated with the receiving device, or the beam coverage information.

In a twenty-fifth aspect, alone or in combination with one or more of the twentieth through twenty-fourth aspects, the aggregated signal comprises at least one uplink retuning gap.

In a twenty-sixth aspect, alone or in combination with one or more of the first through twenty-fifth aspects, at least one of the transmitting device or the receiving device comprises a non-terrestrial device.

In a twenty-seventh aspect, alone or in combination with the twenty-sixth aspect, the non-terrestrial device is associated with a satellite.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a receiving device, or a receiving device may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a communication manager 808. The communication manager 808 may include a determination component 810.

In some aspects, the apparatus 800 may be configured to perform one or more operations described herein in connection with FIGS. 4 and 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the base station or the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 806. In some aspects, the reception component 802 may include one or more antennas, a modem, a demodulator, a MIMO detector, a receive processor, a controller/processor, a memory, or a combination thereof, of the base station or the UE described in connection with FIG. 2.

The transmission component 804 may transmit communications, such as reference signals, control information, data communications, or a combination thereof, to the apparatus 806. In some aspects, one or more other components of the apparatus 806 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the base station or the UE described in connection with FIG. 2. In some aspects, the transmission component 804 may be co-located with the reception component 802 in a transceiver.

The reception component 802 may receive, from a transmitting device, an aggregated signal including a plurality of FDM signals corresponding to a plurality of beams, each of the plurality of FDM signals comprising a waveform associated with a respective iFFT component of a plurality of iFFT components. The reception component 802 may decode the plurality of FDM signals.

The determination component 810 may determine the plurality of FDM signals based at least in part on at least one of a plurality of respective carrier frequencies corresponding to the plurality of FDM signals or a plurality of respective polarizations corresponding to the plurality of FDM signals. In some aspects, the determination component 810 may include one or more antennas, a modem, a modulator, a transmit MIMO processor, a transmit processor, a controller/processor, a memory, or a combination thereof, of the base station or the UE described in connection with FIG. 2. In some aspects, the determination component 810 may include the reception component 802 and/or the transmission component 804.

The communication manager 808 and/or the reception component 802 may obtain the geographical location from a GNSS. In some aspects, the communication manager 808 may include one or more antennas, a modem, a modulator, a transmit MIMO processor, a transmit processor, a controller/processor, a memory, or a combination thereof, of the base station or the UE described in connection with FIG. 2. In some aspects, the communication manager 808 may include the reception component 802 and/or the transmission component 804.

The reception component 802 may receive system information, The communication manager 808 may obtain, from the system information, at least one of ephemeris information or beam coverage information. The reception component 802 may receive the beam coverage information via at least one of an RRC message, a MAC CE, or a DCI transmission. The reception component 802 may hop between the plurality of beams.

The transmission component 804 may transmit a capability report to the transmitting device that indicates retuning gap capability information, wherein the at least one retuning gap is based at least in part on the retuning gap capability information.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

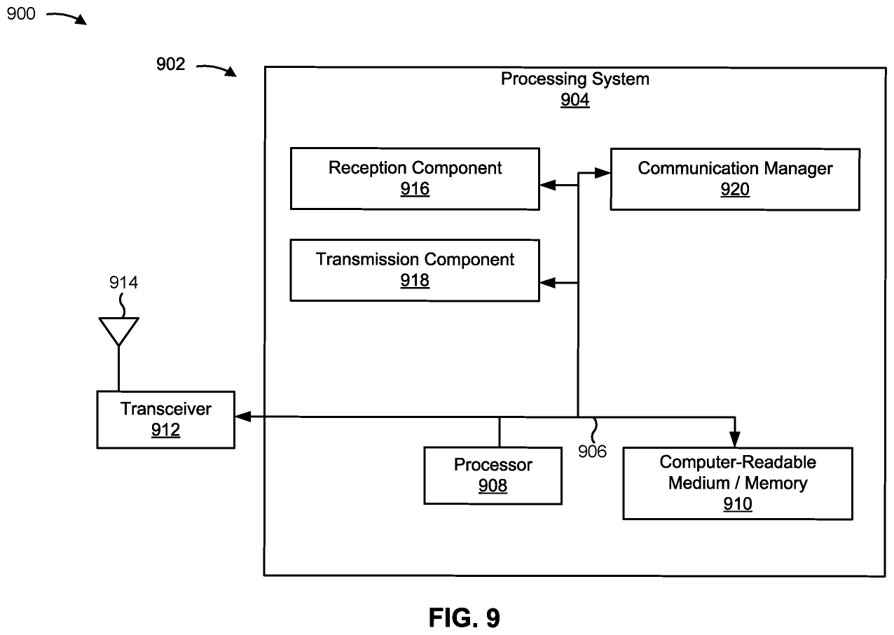

FIG. 9 is a diagram illustrating an example 900 of a hardware implementation for an apparatus 902 employing a processing system 904. The apparatus 902 may be, be similar to, include, or be included in the apparatus 800 shown in FIG. 8. For example, the apparatus 902 may be. or include, a base station or a UE.

The processing system 904 may be implemented with a bus architecture, represented generally by the bus 906. The bus 906 may include any number of interconnecting buses and bridges depending on the specific application of the processing system 904 and the overall design constraints. The bus 906 links together various circuits including one or more processors and/or hardware components, represented by a processor 908, the illustrated components, and the computer-readable medium/memory 910. The bus 906 may also link various other circuits, such as timing sources, peripherals, voltage regulators, power management circuits, and/or the like.

The processing system 904 may be coupled to a transceiver 912. The transceiver 912 is coupled to one or more antennas 914. The transceiver 912 provides a means for communicating with various other apparatuses over a transmission medium. The transceiver 912 receives a signal from the one or more antennas 914, extracts information from the received signal, and provides the extracted information to the processing system 904, specifically a reception component 916. In addition, the transceiver 912 receives information from the processing system 904, specifically a transmission component 918, and generates a signal to be applied to the one or more antennas 914 based at least in part on the received information.

The processor 908 is coupled to the computer-readable medium/memory 910. The processor 908 is responsible for general processing, including the execution of software stored on the computer-readable medium/memory 910. The software, when executed by the processor 908, causes the processing system 904 to perform the various functions described herein in connection with a receiving device. The computer-readable medium/memory 910 may also be used for storing data that is manipulated by the processor 908 when executing software. The processing system also may include a communication manager 920. The communication manager 920 may organize, prioritize, activate, facilitate and/or otherwise manage communication operations performed by the apparatus 902. The processing system 904 may include any number of additional components not illustrated in FIG. 9. The components illustrated and/or not illustrated may be software modules running in the processor 908, resident/stored in the computer readable medium/memory 910, one or more hardware modules coupled to the processor 908, or some combination thereof.

In some aspects, the processing system 904 may be a component of the base station 110 and may include the memory 242 and/or at least one of the TX MIMO processor 230, the receive processor 238, and/or the controller/processor 240. In some aspects, the processing system 904 may be a component of the UE 120 and may include the memory 282 and/or at least one of the TX MIMO processor 266, the receive processor 258, and/or the controller/processor 280. In some aspects, the apparatus 902 for wireless communication provides means for receiving, from a transmitting device, an aggregated signal including a plurality of FDM signals corresponding to a plurality of beams, each of the plurality of FDM signals comprising a waveform associated with a respective iFFT component of a plurality of iFFT components: and means for decoding the plurality of FDM signals.

In some aspects, the apparatus 902 for wireless communication provides means for determining the plurality of FDM signals based at least in part on at least one of a plurality of respective carrier frequencies corresponding to the plurality of FDM signals or a plurality of respective polarizations corresponding to the plurality of FDM signals. In some aspects, the apparatus 902 for wireless communication provides means for obtaining a geographical location from a global navigation satellite system. In some aspects, the apparatus 902 for wireless communication provides means for receiving system information: and obtaining, from the system information, at least one of ephemeris information or beam coverage information. In some aspects, the apparatus 902 for wireless communication provides means for receiving the beam coverage information via at least one of an RRC message, a MAC CE, or a DCI transmission. In some aspects, the apparatus 902 for wireless communication provides means for hopping between the plurality of beams. In some aspects, the apparatus 902 for wireless communication provides means for switching from a first beam of the plurality of beams to a second beam of the plurality of beams during the retuning gap.

In some aspects, the apparatus 902 for wireless communication provides means for performing a hopping having a hopping type, wherein the hopping type comprises: inter-frequency hopping with identical polarization, intra-frequency hopping with different polarization, or inter-frequency hopping with different polarization. In some aspects, the apparatus 902 for wireless communication provides means for transmitting a capability report to the transmitting device that indicates retuning gap capability information, wherein the at least one retuning gap is based at least in part on the retuning gap capability information. In some aspects, the apparatus 902 for wireless communication provides means for performing a BWP switch from a first active BWP to a second active BWP.

The aforementioned means may be one or more of the aforementioned components of the processing system 904 of the apparatus 902 configured to perform the functions recited by the aforementioned means. As described elsewhere herein, the processing system 904 may include the TX MIMO processor 230, the RX processor 238, the controller/processor 240, the memory 282, the TX MIMO processor 266, the receive processor 258, and/or the controller/processor 280. In one configuration, the aforementioned means may be the TX MIMO processor 230, the RX processor 238, the controller/processor 240, the memory 282, the TX MIMO processor 266, the receive processor 258, and/or the controller/processor 280 configured to perform the functions and/or operations recited herein.

FIG. 9 is provided as an example. Other examples may differ from what is described in connection with FIG. 9.

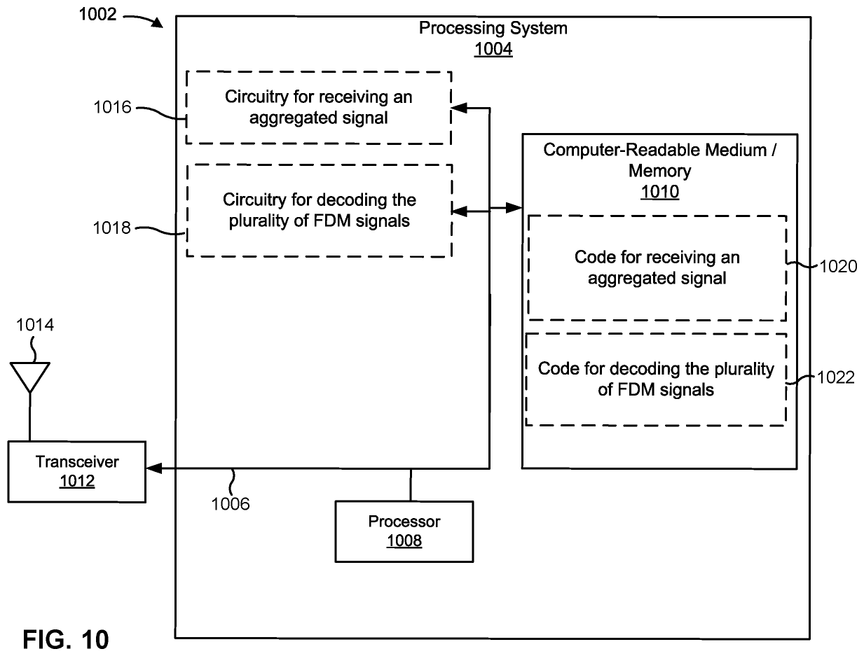

FIG. 10 is a diagram illustrating an example 1000 of an implementation of code and circuitry for an apparatus 1002 for wireless communication. The apparatus 1002 may be, be similar to, include, or be included in the apparatus 800 shown in FIG. 8, and/or the apparatus 902 shown in FIG. 9. For example, the apparatus 1002 may be, or include, a base station. The apparatus 1002 may include a processing system 1004, which may include a bus 1006 coupling one or more components such as, for example, a processor 1008, computer-readable medium/memory 1010, a transceiver 1012, and/or the like. As shown, the transceiver 1012 may be coupled to one or more antennas 1014.

As further shown in FIG. 10, the apparatus 1002 may include circuitry for receiving, from a transmitting device, an aggregated signal including a plurality of FDM signals corresponding to a plurality of beams, each of the plurality of FDM signals comprising a waveform associated with a respective iFFT component of a plurality of iFFT components (circuitry 1016). For example, the apparatus 1002 may include circuitry 1016 to enable the apparatus 1002 to receive, from a transmitting device, an aggregated signal including a plurality of FDM signals corresponding to a plurality of beams, each of the plurality of FDM signals comprising a waveform associated with a respective iFFT component of a plurality of iFFT components.

As further shown in FIG. 10, the apparatus 1002 may include circuitry for decoding the plurality of FDM signals (circuitry 1018). For example, the apparatus 1002 may include circuitry 1018 to enable the apparatus 1002 to decode the plurality of FDM signals.

As further shown in FIG. 10, the apparatus 1002 may include, stored in computer-readable medium 1010, code for receiving, from a transmitting device, an aggregated signal including a plurality of FDM signals corresponding to a plurality of beams, each of the plurality of FDM signals comprising a waveform associated with a respective iFFT component of a plurality of iFFT components (code 1020). For example, the apparatus 1002 may include code 1020 that, when executed by the processor 1008, may cause the transceiver 1012 receive, from a transmitting device, an aggregated signal including a plurality of FDM signals corresponding to a plurality of beams, each of the plurality of FDM signals comprising a waveform associated with a respective iFFT component of a plurality of iFFT components.

As further shown in FIG. 10, the apparatus 1002 may include, stored in computer-readable medium 1010, code for decoding the plurality of FDM signals (code 1022). For example, the apparatus 1002 may include code 1022 that, when executed by the processor 1008, may cause the apparatus 1002 to decode the plurality of FDM signals.

FIG. 10 is provided as an example. Other examples may differ from what is described in connection with FIG. 10.

FIG. 11 is a diagram of an example apparatus 1100 for wireless communication. The apparatus 1100 may be a transmitting device, or a transmitting device may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108. The communication manager 1108 may include a generation component 1110.

In some aspects, the apparatus 1100 may be configured to perform one or more operations described herein in connection with FIGS. 4 and 5. Additionally, or alternatively, the apparatus 1100 may be configured to perform one or more processes described herein, such as process 700 of FIG. 7. In some aspects, the apparatus 1100 and/or one or more components shown in FIG. 11 may include one or more components of the base station or UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a modem, a demodulator, a MIMO detector, a receive processor, a controller/processor, a memory, or a combination thereof, of the base station or UE described in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the base station or UE described in connection with FIG. 2. In some aspects, the transmission component 1104 may be co-located with the reception component 1102 in a transceiver.

The generation component 1110 may generate, using a plurality of iFFT components, an aggregated signal including a plurality of FDM signals corresponding to a plurality of beams, each of the plurality of FDM signals comprising a waveform associated with a respective iFFT component of the plurality of iFFT components. In some aspects, the generation component 1110 may include one or more antennas, a modem, a modulator, a transmit MIMO processor, a transmit processor, a controller/processor, a memory, or a combination thereof, of the base station or UE described in connection with FIG. 2. In some aspects, the generation component 1110 may include the reception component 1102 and/or the transmission component 1104.

The transmission component 1104 may transmit the aggregated signal to a receiving device.

The generation component 1110 may generate the plurality of FDM signals based at least in part on at least one of a plurality of respective carrier frequencies corresponding to the plurality of FDM signals or a plurality of respective polarizations corresponding to the plurality of FDM signals.

The communication manager 1108 may obtain geographical location from a GNSS. In some aspects, the communication manager 1108 may include one or more antennas, a modem, a modulator, a transmit MIMO processor, a transmit processor, a controller/processor, a memory, or a combination thereof, of the base station or UE described in connection with FIG. 2. In some aspects, the communication manager 1108 may include the reception component 1102 and/or the transmission component 1104.

The transmission component 1104 may transmit system information that indicates at least one of ephemeris information or beam coverage information. The transmission component 1104 may transmit the beam coverage information via at least one of an RRC message, a MAC CE, or a DCI transmission.

The reception component 1102 may hop between the plurality of beams. The reception component 1102 may receive a capability report from the receiving device that indicates retuning gap capability information, wherein the at least one retuning gap is based at least in part on the retuning gap capability information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

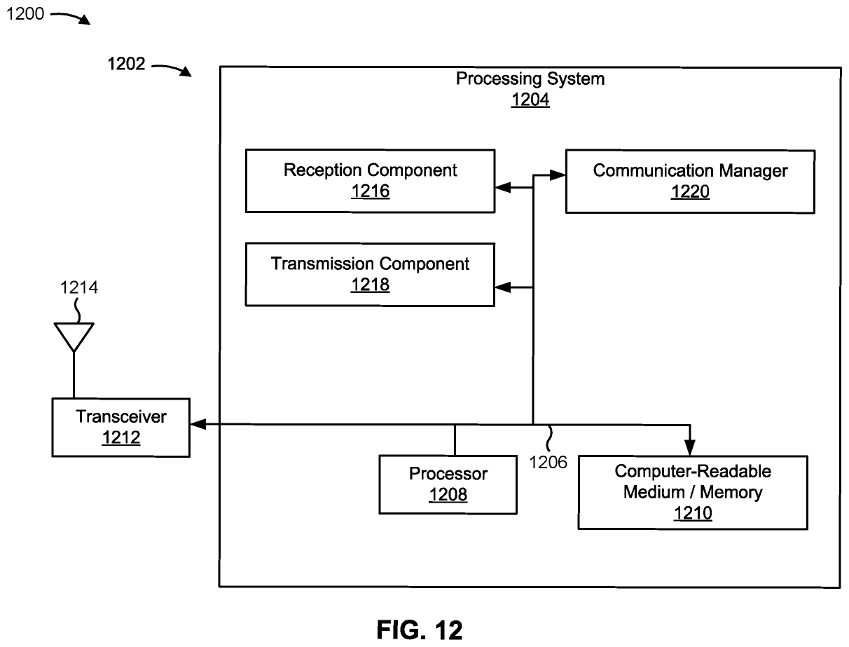

FIG. 12 is a diagram illustrating an example 1200 of a hardware implementation for an apparatus 1202 employing a processing system 1204. The apparatus 1202 may be, be similar to, include, or be included in the apparatus 1100 shown in FIG. 11. For example, the apparatus 1202 may be, or include, a base station or a UE.

The processing system 1204 may be implemented with a bus architecture, represented generally by the bus 1206. The bus 1206 may include any number of interconnecting buses and bridges depending on the specific application of the processing system 1204 and the overall design constraints. The bus 1206 links together various circuits including one or more processors and/or hardware components, represented by a processor 1208, the illustrated components, and the computer-readable medium/memory 1210. The bus 1206 may also link various other circuits, such as timing sources, peripherals, voltage regulators, power management circuits, and/or the like.

The processing system 1204 may be coupled to a transceiver 1212. The transceiver 1212 is coupled to one or more antennas 1214. The transceiver 1212 provides a means for communicating with various other apparatuses over a transmission medium. The transceiver 1212 receives a signal from the one or more antennas 1214, extracts information from the received signal, and provides the extracted information to the processing system 1204, specifically a reception component 1216. In addition, the transceiver 1212 receives information from the processing system 1204, specifically a transmission component 1218, and generates a signal to be applied to the one or more antennas 1214 based at least in part on the received information.

The processor 1208 is coupled to the computer-readable medium/memory 1210. The processor 1208 is responsible for general processing, including the execution of software stored on the computer-readable medium/memory 1210. The software, when executed by the processor 1208, causes the processing system 1204 to perform the various functions described herein in connection with a transmitting device. The computer-readable medium/memory 1210 may also be used for storing data that is manipulated by the processor 1208 when executing software. The processing system also may include a communication manager 1220. The communication manager 1220 may organize, prioritize, activate, facilitate and/or otherwise manage communication operations performed by the apparatus 1202. The processing system 1204 may include any number of additional components not illustrated in FIG. 12. The components illustrated and/or not illustrated may be software modules running in the processor 1208, resident/stored in the computer readable medium/memory 1210, one or more hardware modules coupled to the processor 1208, or some combination thereof.

In some aspects, the processing system 1204 may be a component of the base station 110 and may include the memory 242 and/or at least one of the TX MIMO processor 230, the RX processor 238, and/or the controller/processor 240. In some aspects, the processing system 1204 may be a component of the UE 120 and may include the memory 282 and/or at least one of the TX MIMO processor 266, the receive processor 258, and/or the controller/processor 280. In some aspects, the apparatus 1202 for wireless communication provides means for generating, using a plurality of iFFT components, an aggregated signal including a plurality of FDM signals corresponding to a plurality of beams, each of the plurality of FDM signals comprising a waveform associated with a respective iFFT component of the plurality of iFFT components: and means for transmitting the aggregated signal to a receiving device.

In some aspects, the apparatus 1202 for wireless communication provides means for generating the plurality of FDM signals based at least in part on at least one of a plurality of respective carrier frequencies corresponding to the plurality of FDM signals or a plurality of respective polarizations corresponding to the plurality of FDM signals. In some aspects, the apparatus 1202 for wireless communication provides means for obtaining geographical location from a GNSS.

In some aspects, the apparatus 1202 for wireless communication provides means for transmitting system information that indicates at least one of ephemeris information or beam coverage information. In some aspects, the apparatus 1202 for wireless communication provides means for transmitting the beam coverage information via at least one of an RRC message, a MAC CE, or a DCI transmission.

In some aspects, the apparatus 1202 for wireless communication provides means for hopping between the plurality of beams. In some aspects, the apparatus 1202 for wireless communication provides means for switching from a first beam of the plurality of beams to a second beam of the plurality of beams during the retuning gap. In some aspects, the apparatus 1202 for wireless communication provides means for performing a hopping having a hopping type, wherein the hopping type comprises inter-frequency hopping with identical polarization, intra-frequency hopping with different polarization, or inter-frequency hopping with different polarization. In some aspects, the apparatus 1202 for wireless communication provides means for receiving a capability report from the receiving device that indicates retuning gap capability information, wherein the at least one retuning gap is based at least in part on the retuning gap capability information. In some aspects, the apparatus 1202 for wireless communication provides means for performing a BWP switch from a first active BWP to a second active BWP. In some aspects, the apparatus 1202 for wireless communication provides means for transmitting a communication using hopping based uplink beam switching.

The aforementioned means may be one or more of the aforementioned components of the processor 1208 of the apparatus 1202 configured to perform the functions recited by the aforementioned means. As described elsewhere herein, the processing system 1204 may include the TX MIMO processor 230, the receive processor 238, controller/processor 240, the memory 282, the TX MIMO processor 266, the receive processor 258, and/or the controller/processor 280. In one configuration, the aforementioned means may be the TX MIMO processor 230, the receive processor 238, controller/processor 240, the memory 282, the TX MIMO processor 266, the receive processor 258, and/or the controller/processor 280 configured to perform the functions and/or operations recited herein.

FIG. 12 is provided as an example. Other examples may differ from what is described in connection with FIG. 12.

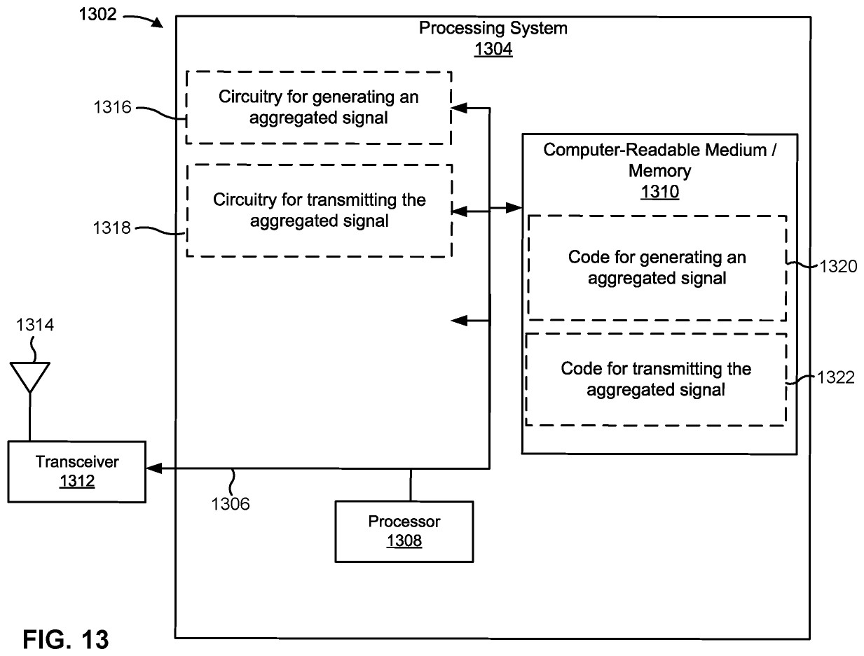

FIG. 13 is a diagram illustrating an example 1300 of an implementation of code and circuitry for an apparatus 1302 for wireless communication. The apparatus 1302 may be, be similar to, include, or be included in the apparatus 1100 shown in FIG. 11, and/or the apparatus 1202 shown in FIG. 12. For example, the apparatus 1302 may be, or include, a base station or a UE. The apparatus 1302 may include a processing system 1304, which may include a bus 1306 coupling one or more components such as, for example, a processor 1308, computer-readable medium/memory 1310, a transceiver 1312, and/or the like. As shown, the transceiver 1312 may be coupled to one or more antenna 1314.

As further shown in FIG. 13, the apparatus 1302 may include circuitry for generating, using a plurality of iFFT components, an aggregated signal including a plurality of FDM signals corresponding to a plurality of beams, each of the plurality of FDM signals comprising a waveform associated with a respective iFFT component of the plurality of iFFT components (circuitry 1316). For example, the apparatus 1302 may include circuitry 1316 to enable the apparatus 1302 to generate, using a plurality of iFFT components, an aggregated signal including a plurality of FDM signals corresponding to a plurality of beams, each of the plurality of FDM signals comprising a waveform associated with a respective iFFT component of the plurality of iFFT components.

As further shown in FIG. 13, the apparatus 1302 may include circuitry for transmitting the aggregated signal to a receiving device (circuitry 1318). For example, the apparatus 1302 may include circuitry 1318 to enable the transceiver 1312 to transmit the aggregated signal to a receiving device.

As further shown in FIG. 13, the apparatus 1302 may include, stored in computer-readable medium 1310, code for generating, using a plurality of iFFT components, an aggregated signal including a plurality of FDM signals corresponding to a plurality of beams, each of the plurality of FDM signals comprising a waveform associated with a respective iFFT component of the plurality of iFFT components (code 1320). For example, the apparatus 1302 may include code 1320 that, when executed by the processor 1308, may cause the apparatus 1302 to generate, using a plurality of iFFT components, an aggregated signal including a plurality of FDM signals corresponding to a plurality of beams, each of the plurality of FDM signals comprising a waveform associated with a respective iFFT component of the plurality of iFFT components.

As further shown in FIG. 13, the apparatus 1302 may include, stored in computer-readable medium 1310, code for transmitting the aggregated signal to a receiving device (code 1322). For example, the apparatus 1302 may include code 1322 that, when executed by the processor 1308, may cause the transceiver 1312 to transmit the aggregated signal to a receiving device.

FIG. 13 is provided as an example. Other examples may differ from what is described in connection with FIG. 13.

The following provides an overview of some Aspects of the present disclosure:

Aspect 1: A method of wireless communication performed by a receiving device, comprising: receiving, from a transmitting device, an aggregated signal including a plurality of frequency division multiplexed (FDM) signals corresponding to a plurality of beams, each of the plurality of FDM signals comprising a waveform associated with a respective inverse fast Fourier transform (iFFT) component of a plurality of iFFT components: and decoding the plurality of FDM signals.

Aspect 2: The method of Aspect 1, wherein the waveform comprises a discrete Fourier transform-spread-orthogonal frequency division multiplexing (DFT-s-OFDM) waveform.

Aspect 3: The method of either of Aspects 1 or 2, further comprising determining the plurality of FDM signals based at least in part on at least one of a plurality of respective carrier frequencies corresponding to the plurality of FDM signals or a plurality of respective polarizations corresponding to the plurality of FDM signals.

Aspect 4: The method of any of Aspects 1-3, wherein the plurality of FDM signals comprises at least one of a physical layer downlink channel communication, a physical layer uplink channel communication, or a reference signal.

Aspect 5: The method of any of Aspects 1-4, wherein decoding the plurality of FDM signals comprises decoding the plurality of FDM signals based at least in part on at least one of: a geographical location of the receiving device, ephemeris information associated with the transmitting device, or beam coverage information.

Aspect 6: The method of Aspect 5, further comprising obtaining the geographical location from a global navigation satellite system.

Aspect 7: The method of either of Aspects 5 or 6, further comprising: receiving system information: and obtaining, from the system information, at least one of the ephemeris information or the beam coverage information.

Aspect 8: The method of any of Aspects 5-7, wherein the beam coverage information comprises at least one beam-specific parameter that indicates at least one of: a carrier frequency, a number of iFFT points, a bandwidth, a subcarrier spacing, an indication of at least one of a portion of a zero-tail of a discrete Fourier transform-spread-orthogonal frequency division multiplexing (DFT-s-OFDM) waveform to be considered or a portion of a zero-head of the DFT-s-OFDM waveform to be considered, a guard interval (GI) sequence to generate a GI in a time domain for a GI-DFT-s-OFDM waveform to be considered, at least a portion of the GI of the GI-DFT-s-OFDM waveform to be considered, or polarization information.

Aspect 9: The method of any of Aspects 5-8, wherein the beam coverage information comprises at least one of user equipment (UE)-specific beam coverage information or UE-group-specific beam coverage information.

Aspect 10: The method of Aspect 9, further comprising receiving the beam coverage information via at least one of a: radio resource control message, a medium access control (MAC) control element (MAC CE), or a downlink control information transmission.

Aspect 11: The method of any of Aspects 1-10, further comprising hopping between the plurality of beams.

Aspect 12: The method of Aspect 11, wherein the aggregated signal comprises at least one retuning gap, and wherein hopping between the plurality of beams comprises switching from a first beam of the plurality of beams to a second beam of the plurality of beams during the retuning gap.

Aspect 13: The method of Aspect 12, wherein switching from the first beam to the second beam comprises an inter-frequency beam switch, and wherein the at least one retuning gap comprises a non-zero retuning gap.

Aspect 14: The method of Aspect 13, wherein a length of the non-zero retuning gap is based at least in part on a frequency offset between a frequency associated with the first beam and a frequency associated with the second beam.

Aspect 15: The method of any of Aspects 12-14, wherein switching from the first beam to the second beam comprises an intra-frequency beam switch, and wherein the at least one retuning gap comprises a zero retuning gap.

Aspect 16: The method of any of Aspects 12-15, wherein switching from the first beam to the second beam comprises performing a hopping having a hopping type, wherein the hopping type comprises: inter-frequency hopping with identical polarization, intra-frequency hopping with different polarization, or inter-frequency hopping with different polarization.

Aspect 17: The method of any of Aspects 12-16, further comprising transmitting a capability report to the transmitting device that indicates retuning gap capability information, wherein the at least one retuning gap is based at least in part on the retuning gap capability information.

Aspect 18: The method of any of Aspects 11-17, wherein hopping between the plurality of beams comprises performing a bandwidth part (BWP) switch from a first active BWP to a second active BWP.

Aspect 19: The method of Aspect 18, wherein each of the first active BWP and the second active BWP has an associated set of parameters that indicates at least one of: a carrier frequency, a number of iFFT points, a bandwidth, a subcarrier spacing, an indication of at least one of a portion of a zero-tail of a discrete Fourier transform-spread-orthogonal frequency division multiplexing (DFT-s-OFDM) waveform to be considered or a portion of a zero-head of the DFT-s-OFDM waveform to be considered, a guard interval (GI) sequence to generate a GI in a time domain for a GI-DFT-s-OFDM waveform to be considered, at least a portion of the GI of the GI-DFT-s-OFDM waveform to be considered, or polarization information.

Aspect 20: The method of any of Aspects 1-19, wherein the receiving device comprises a user equipment (UE), the UE comprising a transceiver.

Aspect 21: The method of any of Aspects 1-19, wherein the transmitting device comprises a user equipment (UE), and wherein the aggregated signal is based at least in part on hopping based uplink beam switching.

Aspect 22: The method of Aspect 21, wherein the hopping based uplink beam switching uses at least one of a frequency resource or a polarization, wherein the at least one of the frequency resource or the polarization is based at least in part on at least one frequency resource or polarization associated with the aggregated signal.

Aspect 23: The method of Aspect 22, wherein the at least one of the frequency resource or the polarization is based at least in part on at least one of a beam switching configuration or a wireless communication standard.

Aspect 24: The method of any of Aspects 21-23, wherein decoding the plurality of FDM signals comprises decoding the plurality of FDM signals based at least in part on at least one of: a geographical location of the UE, ephemeris information associated with the receiving device, or beam coverage information.

Aspect 25: The method of Aspect 24, wherein the hopping based uplink beam switching uses at least one of a frequency resource or a polarization, wherein the at least one of the frequency resource or the polarization is based at least in part on at least one of: the geographical location of the UE, the ephemeris information associated with the receiving device, or the beam coverage information.

Aspect 26: The method of any of Aspects 21-25, wherein the aggregated signal comprises at least one uplink retuning gap.

Aspect 27: The method of any of Aspects 1-26, wherein at least one of the receiving device or the transmitting device comprises a non-terrestrial device.

Aspect 28: The method of Aspect 27, wherein the non-terrestrial device is associated with a satellite.

Aspect 29: A method of wireless communication performed by a transmitting device, comprising: generating, using a plurality of inverse fast Fourier transform (iFFT) components, an aggregated signal including a plurality of frequency division multiplexed (FDM) signals corresponding to a plurality of beams, each of the plurality of FDM signals comprising a waveform associated with a respective iFFT component of the plurality of iFFT components: and transmitting the aggregated signal to a receiving device.

Aspect 30: The method of Aspect 29, wherein the waveform comprises a discrete Fourier transform-spread-orthogonal frequency division multiplexing (DFT-s-OFDM) waveform.

Aspect 31: The method of either of Aspects 29 or 30, further comprising generating the plurality of FDM signals based at least in part on at least one of a plurality of respective carrier frequencies corresponding to the plurality of FDM signals or a plurality of respective polarizations corresponding to the plurality of FDM signals.

Aspect 32: The method of any of Aspects 29-31, wherein the plurality of FDM signals comprises at least one of a physical layer downlink channel communication, a physical layer uplink channel communication, or a reference signal.

Aspect 33: The method of any of Aspects 29-32, wherein transmitting the aggregated signal comprises transmitting the aggregated signal based at least in part on at least one of: a geographical location of the receiving device, ephemeris information associated with the transmitting device, or beam coverage information.

Aspect 34: The method of Aspect 33, further comprising obtaining the geographical location from a global navigation satellite system.

Aspect 35: The method of either of Aspects 33 or 34, further comprising transmitting system information that indicates at least one of the ephemeris information or the beam coverage information.

Aspect 36: The method of any of Aspects 33-35, wherein the beam coverage information comprises at least one beam-specific parameter that indicates at least one of: a carrier frequency, a number of iFFT points, a bandwidth, a subcarrier spacing, an indication of at least one of a portion of a zero-tail of a discrete Fourier transform-spread-orthogonal frequency division multiplexing (DFT-s-OFDM) waveform to be considered or a portion of a zero-head of the DFT-s-OFDM waveform to be considered, a guard interval (GI) sequence to generate a GI in a time domain for a GI-DFT-s-OFDM waveform to be considered, at least a portion of the GI of the GI-DFT-s-OFDM waveform to be considered, or polarization information.

Aspect 37: The method of any of Aspects 33-36, wherein the beam coverage information comprises at least one of user equipment (UE)-specific beam coverage information or UE-group-specific beam coverage information.

Aspect 38: The method of any of Aspects 33-37, further comprising transmitting the beam coverage information via at least one of a: radio resource control message, a medium access control (MAC) control element (MAC CE), or a downlink control information transmission.

Aspect 39: The method of any of Aspects 29-38, further comprising hopping between the plurality of beams.

Aspect 40: The method of Aspect 39, wherein the aggregated signal comprises at least one retuning gap, and wherein hopping between the plurality of beams comprises switching from a first beam of the plurality of beams to a second beam of the plurality of beams during the retuning gap.

Aspect 41: The method of Aspect 40, wherein switching from the first beam to the second beam comprises an inter-frequency beam switch, and wherein the at least one retuning gap comprises a non-zero retuning gap.

Aspect 42: The method of Aspect 41, wherein a length of the non-zero retuning gap is based at least in part on a frequency offset between a frequency associated with the first beam and a frequency associated with the second beam.

Aspect 43: The method of any of Aspects 40-42, wherein switching from the first beam to the second beam comprises an intra-frequency beam switch, and wherein the at least one retuning gap comprises a zero retuning gap.

Aspect 44: The method of any of Aspects 40-43, wherein switching from the first beam to the second beam comprises performing a hopping having a hopping type, wherein the hopping type comprises: inter-frequency hopping with identical polarization, intra-frequency hopping with different polarization, or inter-frequency hopping with different polarization.

Aspect 45: The method of any of Aspects 40-44, further comprising receiving a capability report from the receiving device that indicates retuning gap capability information, wherein the at least one retuning gap is based at least in part on the retuning gap capability information.

Aspect 46: The method of any of Aspects 39-45, wherein hopping between the plurality of beams comprises performing a bandwidth part (BWP) switch from a first active BWP to a second active BWP.

Aspect 47: The method of Aspect 46, wherein each of the first active BWP and the second active BWP has an associated set of parameters that indicates at least one of: a carrier frequency, a number of iFFT points, a bandwidth, a subcarrier spacing, an indication of at least one of a portion of a zero-tail of a discrete Fourier transform-spread-orthogonal frequency division multiplexing (DFT-s-OFDM) waveform to be considered or a portion of a zero-head of the DFT-s-OFDM waveform to be considered, a guard interval (GI) sequence to generate a GI in a time domain for a GI-DFT-s-OFDM waveform to be considered, at least a portion of the GI of the GI-DFT-s-OFDM waveform to be considered, or polarization information.

Aspect 48: The method of any of Aspects 29-47, wherein the receiving device comprises a user equipment (UE), the UE comprising a transceiver.

Aspect 49: The method of any of Aspects 29-47, wherein the transmitting device comprises a user equipment (UE), and wherein the transmitting the aggregated signal comprises transmitting a communication using hopping based uplink beam switching.

Aspect 50: The method of Aspect 49, wherein the hopping based uplink beam switching uses at least one of a frequency resource or a polarization, wherein the at least one of the frequency resource or the polarization is based at least in part on at least one frequency resource or polarization associated with the aggregated signal.

Aspect 51: The method of Aspect 50, wherein the at least one of the frequency resource or the polarization is based at least in part on at least one of a beam switching configuration or a wireless communication standard.

Aspect 52: The method of any of Aspects 49-51, wherein transmitting the aggregated signal comprises transmitting the aggregated signal based at least in part on at least one of: a geographical location of the UE, ephemeris information associated with the receiving device, or beam coverage information.

Aspect 53: The method of Aspect 52, wherein the hopping based uplink beam switching uses at least one of a frequency resource or a polarization, wherein the at least one of the frequency resource or the polarization is based at least in part on at least one of: the geographical location of the UE, the ephemeris information associated with the receiving device, or the beam coverage information.

Aspect 54: The method of any of Aspects 49-53, wherein the aggregated signal comprises at least one uplink retuning gap.

Aspect 55: The method of any of Aspects 29-47, wherein at least one of the transmitting device or the receiving device comprises a non-terrestrial device.

Aspect 56: The method of Aspect 55, wherein the non-terrestrial device is associated with a satellite.

Aspect 57: A method of wireless communication performed by a receiving device, comprising: receiving, from a transmitting device, an aggregated signal including a plurality of frequency division multiplexed (FDM) signals corresponding to a plurality of beams, each of the plurality of FDM signals comprising a waveform associated with a respective inverse fast Fourier transform (iFFT) component of a plurality of iFFT components: and decoding the plurality of FDM signals based at least in part on at least one of: a geographical location, ephemeris information, or beam coverage information.

Aspect 58: The method of Aspect 57, wherein the waveform comprises a discrete Fourier transform-spread-orthogonal frequency division multiplexing (DFT-s-OFDM) waveform.

Aspect 59: The method of either of Aspects 57 or 58, further comprising determining the plurality of FDM signals based at least in part on at least one of a plurality of respective carrier frequencies corresponding to the plurality of FDM signals or a plurality of respective polarizations corresponding to the plurality of FDM signals.

Aspect 60: The method of any of Aspects 57-59, wherein the plurality of FDM signals comprises at least one of a physical layer downlink channel communication, a physical layer uplink channel communication, or a reference signal.

Aspect 61: The method any of Aspects 57-60, further comprising obtaining the geographical location from a global navigation satellite system.

Aspect 62: The method of any of Aspects 57-61, further comprising: receiving system information: and obtaining, from the system information, at least one of the ephemeris information or the beam coverage information.

Aspect 63: The method of any of Aspects 57-62, wherein the beam coverage information comprises at least one beam-specific parameter that indicates at least one of: a carrier frequency, a number of iFFT points, a bandwidth, a subcarrier spacing, an indication of at least one of a portion of a zero-tail of a discrete Fourier transform-spread-orthogonal frequency division multiplexing (DFT-s-OFDM) waveform to be considered or a portion of a zero-head of the DFT-s-OFDM waveform to be considered, a guard interval (GI) sequence to generate a GI in a time domain for a GI-DFT-s-OFDM waveform to be considered, at least a portion of the GI of the GI-DFT-s-OFDM waveform to be considered, or polarization information.

Aspect 64: The method of any of Aspects 57-63, wherein the beam coverage information comprises at least one of user equipment (UE)-specific beam coverage information or UE-group-specific beam coverage information.

Aspect 65: The method of Aspect 64, further comprising receiving the beam coverage information via at least one of a: radio resource control message, a medium access control (MAC) control element (MAC CE), or a downlink control information transmission.

Aspect 66: The method of any of Aspects 57-65, further comprising hopping between the plurality of beams.

Aspect 67: The method of Aspect 66, wherein the aggregated signal comprises at least one retuning gap, and wherein hopping between the plurality of beams comprises switching from a first beam of the plurality of beams to a second beam of the plurality of beams during the retuning gap.

Aspect 68: The method of Aspect 67, wherein switching from the first beam to the second beam comprises an inter-frequency beam switch, and wherein the at least one retuning gap comprises a non-zero retuning gap.

Aspect 69: The method of Aspect 68, wherein a length of the non-zero retuning gap is based at least in part on a frequency offset between a frequency associated with the first beam and a frequency associated with the second beam.

Aspect 70: The method of any of Aspects 67-69, wherein switching from the first beam to the second beam comprises an intra-frequency beam switch, and wherein the at least one retuning gap comprises a zero retuning gap.

Aspect 71: The method of any of Aspects 67-70, wherein switching from the first beam to the second beam comprises performing a hopping having a hopping type, wherein the hopping type comprises: inter-frequency hopping with identical polarization, intra-frequency hopping with different polarization, or inter-frequency hopping with different polarization.

Aspect 72: The method of any of Aspects 67-71, further comprising transmitting a capability report to the transmitting device that indicates retuning gap capability information, wherein the at least one retuning gap is based at least in part on the retuning gap capability information.

Aspect 73: The method of any of Aspects 66-72, wherein hopping between the plurality of beams comprises performing a bandwidth part (BWP) switch from a first active BWP to a second active BWP.

Aspect 74: The method of Aspect 73, wherein each of the first active BWP and the second active BWP has an associated set of parameters that indicates at least one of: a carrier frequency, a number of iFFT points, a bandwidth, a subcarrier spacing, an indication of at least one of a portion of a zero-tail of a discrete Fourier transform-spread-orthogonal frequency division multiplexing (DFT-s-OFDM) waveform to be considered or a portion of a zero-head of the DFT-s-OFDM waveform to be considered, a guard interval (GI) sequence to generate a GI in a time domain for a GI-DFT-s-OFDM waveform to be considered, at least a portion of the GI of the GI-DFT-s-OFDM waveform to be considered, or polarization information.

Aspect 75: The method of any of Aspects 57-74, wherein the receiving device comprises a user equipment (UE), the UE comprising a transceiver.

Aspect 76: The method of Aspect 75, wherein the geographical location comprises a geographical location of the UE, and wherein the ephemeris information comprises ephemeris information associated with the transmitting device.

Aspect 77: The method of any of Aspects 57-74, wherein the transmitting device comprises a user equipment (UE), and wherein the aggregated signal is based at least in part on hopping based uplink beam switching.

Aspect 78: The method of Aspect 77, wherein the hopping based uplink beam switching uses at least one of a frequency resource or a polarization, wherein the at least one of the frequency resource or the polarization is based at least in part on at least one frequency resource or polarization associated with the aggregated signal.

Aspect 79: The method of Aspect 78, wherein the at least one of the frequency resource or the polarization is based at least in part on at least one of a beam switching configuration or a wireless communication standard.

Aspect 80: The method of any of Aspects 77-79, wherein the geographical location comprises geographical location of the UE, and wherein the ephemeris information comprises ephemeris information associated with the receiving device.

Aspect 81: The method of Aspect 80, wherein the hopping based uplink beam switching uses at least one of a frequency resource or a polarization, wherein the at least one of the frequency resource or the polarization is based at least in part on at least one of: the geographical location of the UE, the ephemeris information associated with the receiving device, or the beam coverage information.

Aspect 82: The method of any of Aspects 77-81, wherein the aggregated signal comprises at least one uplink retuning gap.

Aspect 83: The method of any of Aspects 57-82, wherein at least one of the receiving device or the transmitting device comprises a non-terrestrial device.

Aspect 84: The method of Aspect 83, wherein the non-terrestrial device is associated with a satellite.

Aspect 85: A method of wireless communication performed by a transmitting device, comprising: generating, using a plurality of inverse fast Fourier transform (iFFT) components, an aggregated signal including a plurality of frequency division multiplexed (FDM) signals corresponding to a plurality of beams, each of the plurality of FDM signals comprising a waveform associated with a respective iFFT component of the plurality of iFFT components: and transmitting the aggregated signal to a receiving device based at least in part on at least one of: a geographical location, ephemeris information, or beam coverage information.

Aspect 86: The method of Aspect 85, wherein the waveform comprises a discrete Fourier transform-spread-orthogonal frequency division multiplexing (DFT-s-OFDM) waveform.

Aspect 87: The method of either of Aspects 85 or 86, further comprising generating the plurality of FDM signals based at least in part on at least one of a plurality of respective carrier frequencies corresponding to the plurality of FDM signals or a plurality of respective polarizations corresponding to the plurality of FDM signals.

Aspect 88: The method of any of Aspects 85-87, wherein the plurality of FDM signals comprises at least one of a physical layer downlink channel communication, a physical layer uplink channel communication, or a reference signal.

Aspect 89: The method of any of Aspects 85-88, further comprising obtaining the geographical location from a global navigation satellite system.

Aspect 90: The method of any of Aspects 85-89, further comprising transmitting system information that indicates at least one of the ephemeris information or the beam coverage information.

Aspect 91: The method of any of Aspects 85-90, wherein the beam coverage information comprises at least one beam-specific parameter that indicates at least one of: a carrier frequency, a number of iFFT points, a bandwidth, a subcarrier spacing, an indication of at least one of a portion of a zero-tail of a discrete Fourier transform-spread-orthogonal frequency division multiplexing (DFT-s-OFDM) waveform to be considered or a portion of a zero-head of the DFT-s-OFDM waveform to be considered, a guard interval (GI) sequence to generate a GI in a time domain for a GI-DFT-s-OFDM waveform to be considered, at least a portion of the GI of the GI-DFT-s-OFDM waveform to be considered, or polarization information.

Aspect 92: The method of any of Aspects 85-91, wherein the beam coverage information comprises at least one of user equipment (UE)-specific beam coverage information or UE-group-specific beam coverage information.

Aspect 93: The method of any of Aspects 85-92, further comprising transmitting the beam coverage information via at least one of a: radio resource control message, a medium access control (MAC) control element (MAC CE), or a downlink control information transmission.

Aspect 94: The method of any of Aspects 85-93, further comprising hopping between the plurality of beams.

Aspect 95: The method of Aspect 94, wherein the aggregated signal comprises at least one retuning gap, and wherein hopping between the plurality of beams comprises switching from a first beam of the plurality of beams to a second beam of the plurality of beams during the retuning gap.

Aspect 96: The method of Aspect 95, wherein switching from the first beam to the second beam comprises an inter-frequency beam switch, and wherein the at least one retuning gap comprises a non-zero retuning gap.

Aspect 97: The method of Aspect 96, wherein a length of the non-zero retuning gap is based at least in part on a frequency offset between a frequency associated with the first beam and a frequency associated with the second beam,

Aspect 98: The method of any of Aspects 95-97, wherein switching from the first beam to the second beam comprises an intra-frequency beam switch, and wherein the at least one retuning gap comprises a zero retuning gap.

Aspect 99: The method of any of Aspects 95-98, wherein switching from the first beam to the second beam comprises performing a hopping having a hopping type, wherein the hopping type comprises: inter-frequency hopping with identical polarization, intra-frequency hopping with different polarization, or inter-frequency hopping with different polarization.

Aspect 100: The method of any of Aspects 95-99, further comprising receiving a capability report from the receiving device that indicates retuning gap capability information, wherein the at least one retuning gap is based at least in part on the retuning gap capability information.

Aspect 101: The method of any of Aspects 94-100, wherein hopping between the plurality of beams comprises performing a bandwidth part (BWP) switch from a first active BWP to a second active BWP.

Aspect 102: The method of Aspect 101, wherein each of the first active BWP and the second active BWP has an associated set of parameters that indicates at least one of: a carrier frequency, a number of iFFT points, a bandwidth, a subcarrier spacing, an indication of at least one of a portion of a zero-tail of a discrete Fourier transform-spread-orthogonal frequency division multiplexing (DFT-s-OFDM) waveform to be considered or a portion of a zero-head of the DFT-s-OFDM waveform to be considered, a guard interval (GI) sequence to generate a GI in a time domain for a GI-DFT-s-OFDM waveform to be considered, at least a portion of the GI of the GI-DFT-s-OFDM waveform to be considered, or polarization information.

Aspect 103: The method of any of Aspects 85-102, wherein the receiving device comprises a user equipment (UE), the UE comprising a transceiver.

Aspect 104: The method of Aspect 103, wherein the geographical location comprises a geographical location of the UE, and wherein the ephemeris information comprises ephemeris information associated with the transmitting device.

Aspect 105: The method of any of Aspects 85-102, wherein the transmitting device comprises a user equipment (UE), and wherein the transmitting the aggregated signal comprises transmitting a communication using hopping based uplink beam switching.

Aspect 106: The method of Aspect 105, wherein the hopping based uplink beam switching uses at least one of a frequency resource or a polarization, wherein the at least one of the frequency resource or the polarization is based at least in part on at least one frequency resource or polarization associated with the aggregated signal.

Aspect 107: The method of Aspect 106, wherein the at least one of the frequency resource or the polarization is based at least in part on at least one of a beam switching configuration or a wireless communication standard.

Aspect 108: The method of any of Aspects 105-107, wherein the geographical location comprises a geographical location of the UE, and wherein the ephemeris information comprises ephemeris information associated with the receiving device.

Aspect 109: The method of Aspect 108, wherein the hopping based uplink beam switching uses at least one of a frequency resource or a polarization, wherein the at least one of the frequency resource or the polarization is based at least in part on at least one of: the geographical location of the UE, the ephemeris information associated with the receiving device, or the beam coverage information.

Aspect 110: The method of any of Aspects 105-109, wherein the aggregated signal comprises at least one uplink retuning gap.

Aspect 111: The method of any of Aspects 85-110, wherein at least one of the transmitting device or the receiving device comprises a non-terrestrial device.

Aspect 112: The method of Aspect 111, wherein the non-terrestrial device is associated with a satellite.

Aspect 113: An apparatus for wireless communication at a device, comprising a processor: memory coupled with the processor: and instructions stored in the memory and executable by the processor to cause the apparatus to perform the method of one or more of Aspects 1-28.

Aspect 114: A device for wireless communication, comprising a memory and one or more processors coupled to the memory, the one or more processors configured to perform the method of one or more of Aspects 1-28.

Aspect 115: An apparatus for wireless communication, comprising at least one means for performing the method of one or more of Aspects 1-28.

Aspect 116: A non-transitory computer-readable medium storing code for wireless communication, the code comprising instructions executable by a processor to perform the method of one or more of Aspects 1-28.

Aspect 117: A non-transitory computer-readable medium storing a set of instructions for wireless communication, the set of instructions comprising one or more instructions that, when executed by one or more processors of a device, cause the device to perform the method of one or more of Aspects 1-28.

Aspect 118: An apparatus for wireless communication at a device, comprising a processor: memory coupled with the processor: and instructions stored in the memory and executable by the processor to cause the apparatus to perform the method of one or more of Aspects 29-56.

Aspect 119: A device for wireless communication, comprising a memory and one or more processors coupled to the memory, the one or more processors configured to perform the method of one or more of Aspects 29-56.

Aspect 120: An apparatus for wireless communication, comprising at least one means for performing the method of one or more of Aspects 29-56.

Aspect 121: A non-transitory computer-readable medium storing code for wireless communication, the code comprising instructions executable by a processor to perform the method of one or more of Aspects 29-56.

Aspect 122: A non-transitory computer-readable medium storing a set of instructions for wireless communication, the set of instructions comprising one or more instructions that, when executed by one or more processors of a device, cause the device to perform the method of one or more of Aspects 29-56.

Aspect 123: An apparatus for wireless communication at a device, comprising a processor: memory coupled with the processor: and instructions stored in the memory and executable by the processor to cause the apparatus to perform the method of one or more of Aspects 57-84.

Aspect 124: A device for wireless communication, comprising a memory and one or more processors coupled to the memory, the one or more processors configured to perform the method of one or more of Aspects 57-84.

Aspect 125: An apparatus for wireless communication, comprising at least one means for performing the method of one or more of Aspects 57-84.

Aspect 126: A non-transitory computer-readable medium storing code for wireless communication, the code comprising instructions executable by a processor to perform the method of one or more of Aspects 57-84.

Aspect 127: A non-transitory computer-readable medium storing a set of instructions for wireless communication, the set of instructions comprising one or more instructions that, when executed by one or more processors of a device, cause the device to perform the method of one or more of Aspects 57-84.

Aspect 128: An apparatus for wireless communication at a device, comprising a processor: memory coupled with the processor: and instructions stored in the memory and executable by the processor to cause the apparatus to perform the method of one or more of Aspects 85-112.

Aspect 129: A device for wireless communication, comprising a memory and one or more processors coupled to the memory, the one or more processors configured to perform the method of one or more of Aspects 85-112.

Aspect 130: An apparatus for wireless communication, comprising at least one means for performing the method of one or more of Aspects 85-112.

Aspect 131: A non-transitory computer-readable medium storing code for wireless communication, the code comprising instructions executable by a processor to perform the method of one or more of Aspects 85-112.

Aspect 132: A non-transitory computer-readable medium storing a set of instructions for wireless communication, the set of instructions comprising one or more instructions that, when executed by one or more processors of a device, cause the device to perform the method of one or more of Aspects 85-112.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a receiving device, comprising:
a memory; and
one or more processors, coupled to the memory, the memory and the one or more processors configured to:
receive, from a transmitting device, an aggregated signal including a plurality of frequency division multiplexed (FDM) signals corresponding to a plurality of beams, each of the plurality of FDM signals comprising a waveform associated with a respective inverse fast Fourier transform (iFFT) component of a plurality of iFFT components: and
decode the plurality of FDM signals based at least in part on at least one of:
a geographical location,
ephemeris information, or
beam coverage information.

2. The apparatus of claim 1, wherein the waveform comprises a discrete Fourier transform-spread-orthogonal frequency division multiplexing (DFT-s-OFDM) waveform.

3. The apparatus of claim 1, wherein the memory and the one or more processors are further configured to determine the plurality of FDM signals based at least in part on at least one of a plurality of respective carrier frequencies corresponding to the plurality of FDM signals or a plurality of respective polarizations corresponding to the plurality of FDM signals.

4. The apparatus of claim 1, wherein the plurality of FDM signals comprises at least one of a physical layer downlink channel communication, a physical layer uplink channel communication, or a reference signal.

5. The apparatus of claim 1, wherein the memory and the one or more processors are further configured to obtain the geographical location from a global navigation satellite system.

6. The apparatus of claim 1, wherein the memory and the one or more processors are further configured to:
receive system information; and
obtain, from the system information, at least one of the ephemeris information or the beam coverage information.

7. The apparatus of claim 1, wherein the beam coverage information comprises at least one beam-specific parameter that indicates at least one of:
a carrier frequency,
a number of iFFT points,
a bandwidth,
a subcarrier spacing,
an indication of at least one of a portion of a zero-tail of a discrete Fourier transform-spread-orthogonal frequency division multiplexing (DFT-s-OFDM) waveform to be considered or a portion of a zero-head of the DFT-s-OFDM waveform to be considered,
a guard interval (GI) sequence to generate a GI in a time domain for a GI-DFT-s-OFDM waveform to be considered,
at least a portion of the GI of the GI-DFT-s-OFDM waveform to be considered, or
polarization information.

8. The apparatus of claim 1, wherein the beam coverage information comprises at least one of user equipment (UE)-specific beam coverage information or UE-group-specific beam coverage information.

9. The apparatus of claim 8, wherein the memory and the one or more processors are further configured to receive the beam coverage information via at least one of a:
radio resource control message,
a medium access control (MAC) control element (MAC CE), or
a downlink control information transmission.

10. The apparatus of claim 1, wherein the memory and the one or more processors are further configured to hop between the plurality of beams.

11. The apparatus of claim 10, wherein the aggregated signal comprises at least one retuning gap, and wherein the memory and the one or more processors, to hop between the plurality of beams, are configured to switch from a first beam of the plurality of beams to a second beam of the plurality of beams during the at least one retuning gap.

12. The apparatus of claim 11, wherein the memory and the one or more processors, to switch from the first beam to the second beam, are configured to perform an inter-frequency beam switch, and wherein the at least one retuning gap comprises a non-zero retuning gap.

13. The apparatus of claim 12, wherein a length of the non-zero retuning gap is based at least in part on a frequency offset between a frequency associated with the first beam and a frequency associated with the second beam.

14. The apparatus of claim 11, wherein the memory and the one or more processors, to switch from the first beam to the second beam, are configured to perform an intra-frequency beam switch, and wherein the at least one retuning gap comprises a zero retuning gap.

15. The apparatus of claim 11, wherein the memory and the one or more processors, to switch from the first beam to the second beam, are configured to perform a hopping having a hopping type, wherein the hopping type comprises:
inter-frequency hopping with identical polarization,
intra-frequency hopping with different polarization, or
inter-frequency hopping with different polarization.

16. The apparatus of claim 11, wherein the memory and the one or more processors are further configured to transmit a capability report to the transmitting device that indicates retuning gap capability information, wherein the at least one retuning gap is based at least in part on the retuning gap capability information.

17. The apparatus of claim 10, wherein the one or more processors, to hop between the plurality of beams, are configured to perform a bandwidth part (BWP) switch from a first active BWP to a second active BWP, and
wherein each of the first active BWP and the second active BWP has an associated set of parameters that indicates at least one of:
a carrier frequency,
a number of iFFT points,
a bandwidth,
a subcarrier spacing,
an indication of at least one of a portion of a zero-tail of a discrete Fourier transform-spread-orthogonal frequency division multiplexing (DFT-s-OFDM) waveform to be considered or a portion of a zero-head of the DFT-s-OFDM waveform to be considered,
a guard interval (GI) sequence to generate a GI in a time domain for a GI-DFT-s-OFDM waveform to be considered,
at least a portion of the GI of the GI-DFT-s-OFDM waveform to be considered, or
polarization information.

18. The apparatus of claim 1, wherein the receiving device comprises a user equipment (UE), the UE comprising a transceiver,
wherein the geographical location comprises a geographical location of the UE, and
wherein the ephemeris information comprises ephemeris information associated with the transmitting device.

19. The apparatus of claim 1, wherein the transmitting device comprises a user equipment (UE), the UE comprising a transceiver,
wherein the aggregated signal is based at least in part on hopping based uplink beam switching,
wherein the geographical location comprises a geographical location of the UE, and
wherein the ephemeris information comprises ephemeris information associated with the receiving device.

20. The apparatus of claim 19, wherein the hopping based uplink beam switching uses at least one of a frequency resource or a polarization, wherein the at least one of the frequency resource or the polarization is based at least in part on at least one frequency resource or polarization associated with the aggregated signal.

21. The apparatus of claim 20, wherein the at least one of the frequency resource or the polarization is based at least in part on at least one of a beam switching configuration or a wireless communication standard.

22. The apparatus of claim 19, wherein the hopping based uplink beam switching uses at least one of a frequency resource or a polarization, wherein the at least one of the frequency resource or the polarization is based at least in part on at least one of:
the geographical location of the UE,
the ephemeris information associated with the receiving device, or
the beam coverage information.

23. The apparatus of claim 19, wherein the aggregated signal comprises at least one uplink retuning gap.

24. The apparatus of claim 1, wherein at least one of the receiving device or the transmitting device comprises a non-terrestrial device.

25. An apparatus for wireless communication at a transmitting device, comprising:
a memory: and
one or more processors, coupled to the memory, the memory and the one or more processors configured to:
generate, using a plurality of inverse fast Fourier transform (iFFT) components, an aggregated signal including a plurality of frequency division multiplexed (FDM) signals corresponding to a plurality of beams, each of the plurality of FDM signals comprising a waveform associated with a respective iFFT component of the plurality of iFFT components; and
transmit the aggregated signal to a receiving device based at least in part on at least one of a geographical location, ephemeris information, or beam coverage information.

26. The apparatus of claim 25, wherein the transmitting device comprises a user equipment (UE), the UE comprising a transceiver,
wherein the geographical location comprises a geographical location of the UE, and
wherein the ephemeris information comprises ephemeris information associated with the receiving device.

27. The apparatus of claim 25, wherein the receiving device comprises a user equipment (UE),
wherein the aggregated signal is based at least in part on hopping based uplink beam switching,
wherein the geographical location comprises a geographical location of the transmitting device, and
wherein the ephemeris information comprises ephemeris information associated with the transmitting device.

28. The apparatus of claim 27, wherein the hopping based uplink beam switching uses at least one of a frequency resource or a polarization, wherein the at least one of the frequency resource or the polarization is based at least in part on at least one of:
the geographical location of the transmitting device,
the ephemeris information associated with the transmitting device, or
the beam coverage information.

29, A method of wireless communication performed by a receiving device, comprising:
receiving, from a transmitting device, an aggregated signal including a plurality of frequency division multiplexed (FDM) signals corresponding to a plurality of beams, each of the plurality of FDM signals comprising a waveform associated with a respective inverse fast Fourier transform (iFFT) component of a plurality of iFFT components; and
decoding the plurality of FDM signals based at least in part on at least one of a geographical location, ephemeris information, or beam coverage information.

30. A method of wireless communication performed by a transmitting device, comprising:
generating, using a plurality of inverse fast Fourier transform (iFFT) components, an aggregated signal including a plurality of frequency division multiplexed (FDM) signals corresponding to a plurality of beams, each of the plurality of FDM signals comprising a waveform associated with a respective iFFT component of the plurality of iFFT components; and
transmitting the aggregated signal to a receiving device based at least in part on at least one of a geographical location, ephemeris information, or beam coverage information.
